(19) United States
(12) Patent Application Publication
(10) Pub. No.: US 2026/0279334 A1
(43) Pub. Date: Sep. 17, 2026

(54) SYSTEM

(71) Applicant: SoftBank Group Corp., Tokyo (JP)

(72) Inventor: Yusuke NISHIJIMA, Tokyo (JP)

(73) Assignee: SoftBank Group Corp., Tokyo (JP)

(21) Appl. No.: 19/551,678

(22) Filed: Feb. 27, 2026

Related U.S. Application Data
(60) Provisional application No. 63/772,935, filed on Mar. 17, 2025.

(51) Int. Cl. G10L 13/08; G10L 15/06; G10L 15/26; G10L 25/63

(52) U.S. Cl. CPC G10L 13/08; G10L 15/063; G10L 15/26; G10L 25/63

(57) ABSTRACT

A system includes a processor that is configured to model a voice tempo and an intonation based on voice data by executing a voice modeling unit, generate a response to an inquiry by executing a language processing unit using a natural language processing technique, and convert the generated response into a voice format by executing a voice synthesis unit.

### CROSS-REFERENCE TO RELATED APPLICATION

This application claims the benefit of U.S. Provisional Application No. 63/772,935 filed on Mar. 17, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional dialog systems that provide voice-based responses to user inquiries often suffer from several limitations. First, many systems use fixed or simplistic prosody patterns, resulting in monotonous or unnatural speech that does not adequately reflect tempo or intonation, thereby degrading user experience and reducing the sense of natural conversation. Second, existing systems frequently rely on rule-based or limited-domain natural language processing engines, so that they cannot generate contextually appropriate and accurate responses across diverse industries and inquiry types. Third, even in systems employing machine learning, training and utilization of voice models and language models are often separated and inflexible, making it difficult to adapt models to different speakers, emotional states, and specific business domains. Fourth, when domain-specific terminology or company-specific requirements must be reflected, conventional systems require extensive manual tuning or bespoke implementation, which increases development and maintenance costs and hinders scalability. Therefore, there is a need for a system that can: (i) model tempo and intonation of voices based on diverse voice data, (ii) generate accurate and context-appropriate responses using a large-scale language model, and (iii) flexibly adapt to specific industries and companies while providing natural synthesized speech.

### SUMMARY

In order to solve the above-described problems, the invention provides a system comprising a processor, wherein the processor is configured to model a voice tempo and an intonation based on voice data by executing a voice modeling unit, generate a response to an inquiry by executing a language processing unit using a natural language processing technique, and convert the generated response into a voice format by executing a voice synthesis unit. The processor is further configured to use voice data including voices of a plurality of different speakers covering different situations and emotional expressions, and to extract acoustic features from the voice data and learn patterns of the tempo and the intonation based on the extracted acoustic features in the voice modeling unit. The processor is also configured to use, in the language processing unit, a pre-trained large-scale language model to generate an appropriate response to an inquiry in a text format, and to perform fine-tuning of the large-scale language model using a dataset prepared in accordance with needs of a specific industry or a specific company so as to improve an accuracy of the response. By integrating these functions in a unified processor-controlled system, the invention enables generation of natural, human-like speech that reflects modeled tempo and intonation, while simultaneously providing accurate, domain-adaptive responses that can be efficiently customized for various industries and corporate requirements.

The term “system” refers to an integrated arrangement of hardware and software components that cooperate to perform voice modeling, language processing, and voice synthesis functions under control of at least one processor.

The term “processor” refers to one or more hardware processing units, such as a central processing unit (CPU), graphics processing unit (GPU), or dedicated accelerator, that execute instructions to implement the voice modeling unit, the language processing unit, and the voice synthesis unit.

The term “voice data” refers to digital data representing spoken utterances, including recordings of human speech obtained from a plurality of speakers under various conditions.

The term “voice tempo” refers to a temporal characteristic of speech, including speaking speed, rhythm, and timing of utterances, as derived from the voice data.

The term “intonation” refers to variations in pitch, stress, and prosodic contour across an utterance, which convey emphasis, emotion, and sentence modality in speech.

The term “voice modeling unit” refers to a functional component implemented by the processor that processes voice data to extract acoustic features and to learn or represent patterns of voice tempo and intonation.

The term “acoustic features” refers to measurable parameters derived from voice data, including but not limited to pitch, energy, formants, spectral characteristics, duration, and pause patterns. The term “patterns of the tempo and the intonation” refers to statistical or learned representations that characterize how tempo and intonation vary over time in speech for different speakers, situations, or emotional states.

The term “natural language processing technique” refers to any algorithmic or machine learning approach that enables understanding, generation, or transformation of human language text, including but not limited to large-scale language models and neural network-based models.

The term “language processing unit” refers to a functional component implemented by the processor that applies natural language processing techniques to generate responses to inquiries in a text format.

The term “inquiry” refers to information provided by a user or an external system that expresses a question, request, or command to which the system is expected to generate a response.

The term “response” refers to a generated output message, in text or voice form, that addresses the content or intent of an inquiry.

The term “voice synthesis unit” refers to a functional component implemented by the processor that converts a text response and associated prosodic information into a voice format suitable for audio output.

The term “voice format” refers to a digital audio representation of speech, such as a waveform or encoded audio stream, that can be reproduced as audible sound.

The term “pre-trained large-scale language model” refers to a machine learning model trained in advance on a large corpus of text data to learn statistical relationships and structures in natural language, and capable of generating or understanding text based on input prompts.

The term “fine-tuning” refers to an additional training process applied to a pre-trained large-scale language model using a domain-specific or company-specific dataset, in order to adapt the model's behavior and improve its performance for targeted tasks or fields.

The term “dataset prepared in accordance with needs of a specific industry or a specific company” refers to a collection of text or related data that reflects terminology, style, and content requirements associated with a particular industry domain or an individual company's operations, policies, or products.

The term “accuracy of the response” refers to the degree to which the generated response is correct, relevant, and appropriate with respect to the content and intent of the received inquiry, including correct use of domain-specific terminology.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

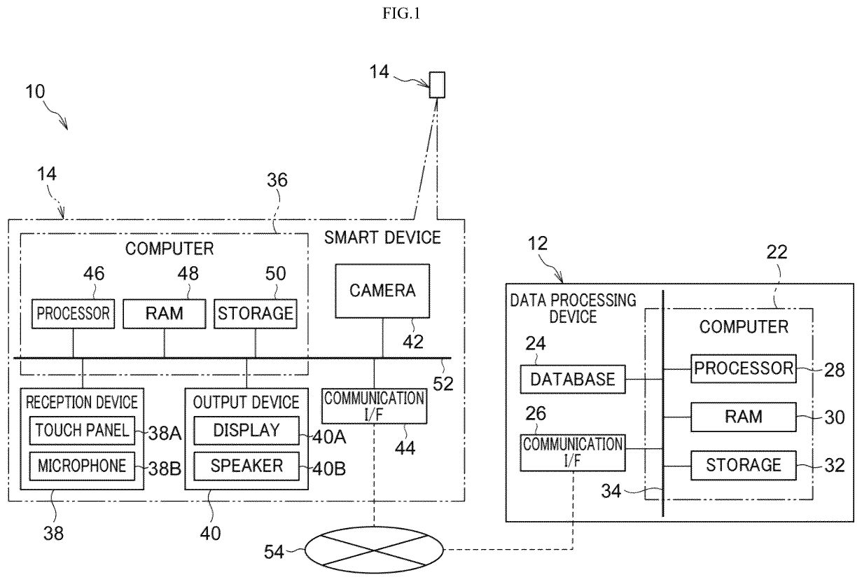

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

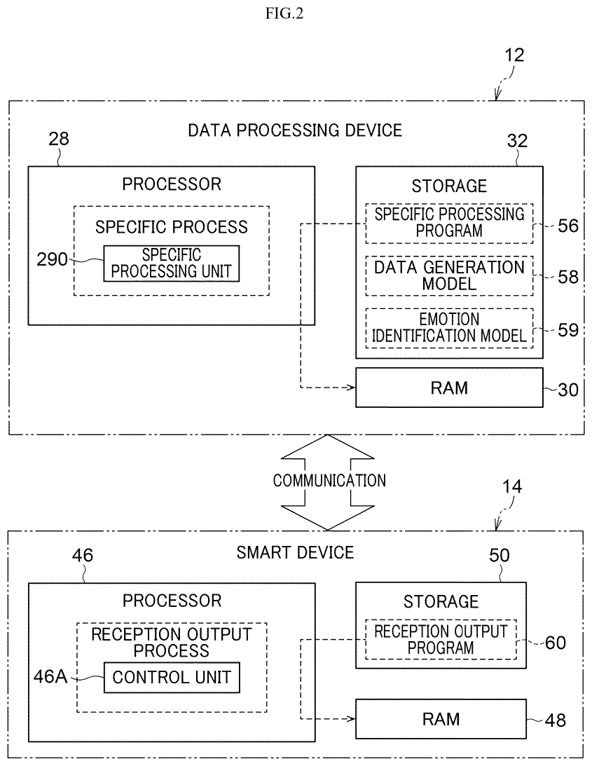

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialog systems that combine natural language processing and speech synthesis often treat text generation and speech output as separate, loosely coupled stages. A natural language processing engine typically produces a generic text response, and a speech synthesis engine subsequently converts the text to audio without explicit awareness of how the text will be spoken, for example, with respect to tempo, prosody, pause positions, and emphasis. This loose coupling leads to several technical problems in computer-implemented dialog systems.

First, a conventional system cannot effectively control the behavior of a generative AI model in a way that is optimized for speech output. Prompt sentences submitted to the generative AI model are typically static or manually designed, and do not dynamically incorporate inquiry content, user attributes, domain-specific constraints, and speech-synthesis-oriented formatting requirements. As a result, the generated text may contain overly long sentences, ambiguous structures, or inappropriate terminology for the intended listener, which degrades the performance of downstream speech synthesis modules and user interface subsystems. Second, many existing systems do not perform integrated management of inquiries, response candidates, speech parameters, and usage histories in a manner that feeds back into model training and control logic. The absence of such integrated feedback prevents the system from systematically improving its generative AI model and audio model with respect to measurable performance indicators such as speech intelligibility, naturalness, listening effort, and latency. Consequently, the computer system cannot adapt its internal models and control parameters based on observed user behavior, domains of use, and response outcomes.

Third, the coordination between user attribute information (for example, age category, language proficiency, or listening condition) and low-level speech control parameters is often rudimentary or rule-based, and does not leverage learned prosody patterns from diverse speakers and contexts. This leads to suboptimal mapping from high-level dialog context to low-level speech parameters in the audio pipeline, and can cause excessive cognitive load on users, especially when listening to complex instructions or explanations generated by a large-scale generative AI model.

Fourth, from a computer technology perspective, existing architectures often do not align the internal structure of prompt generation, language modeling, and speech control in a way that systematically exploits modern processor capabilities. For example, without a dedicated processor-controlled unit that constructs prompt sentences conditioned on accumulated usage data and domain data, the system cannot efficiently utilize high-performance computing resources to generate context-optimized, speech-friendly responses at scale. This results in increased processing overhead, unnecessary network traffic, and inconsistent user experience across sessions and devices.

Accordingly, there is a need for an improved computer-implemented system that: (i) dynamically constructs prompt sentences for a generative AI model based on inquiry content, related information, domain information, and user attributes; (ii) generates response candidates that are structurally optimized for speech synthesis; (iii) derives and applies speech parameters such as speaking rate, prosody, pause positions, and emphasis based on learned audio patterns and user attributes; and (iv) stores and utilizes inquiries, response candidates, speech parameters, and usage histories to continuously improve both the generative AI model and the audio model. Such a system should provide a technical improvement to the functioning of a computer-based dialog platform, including the way processors manage prompt generation, language modeling, speech parameter control, and feedback-based model updating.

The specific processing by the specific processing unit 290 of the data processing device 12 in Example 1 is realized by the following means.

The present invention provides a server comprising a processor configured to execute an audio model processing unit that models speaking characteristics of speakers based on audio information and learns patterns of speech tempo and prosody, execute a language processing unit that generates response candidates to inquiries by utilizing a pre-trained, large-scale generative information processing model, execute a prompt generation unit that dynamically constructs a prompt sentence by combining inquiry content, related information, field-of-use information, user attribute information, and usage history information, and inputs the prompt sentence to the generative information processing model so as to cause the generative information processing model to generate the response candidates in a form suitable for speech synthesis, execute a speech control information generation unit that determines speech parameters including speaking rate, prosody, pause positions, emphasis positions, and sound volume based on the response candidates and the user attribute information and based on the patterns of speech tempo and prosody learned by the audio model processing unit, execute a speech synthesis processing unit that generates audio-form response data from the response candidates in accordance with the determined speech parameters, execute an information management unit that stores inquiries, response candidates, speech parameters, user feedback, and usage histories and uses the stored information to perform learning and updating of the generative information processing model and the audio model processing unit, and execute a user interaction unit that controls user input operations, response display, and audio playback. This enables an integrated computer-implemented dialog platform in which the processor dynamically controls prompt sentences and speech parameters in coordination with generative modeling and audio modeling, thereby improving the technical performance of the system in terms of response quality, speech intelligibility, adaptability to user attributes, and overall efficiency of the dialog processing pipeline.

The term “audio information” refers to data representing sound, including but not limited to digitized waveforms, sampled audio signals, or encoded audio streams that capture human speech or other acoustic events.

The term “speaking characteristics” refers to properties of speech production by a speaker, including but not limited to speaking rate, rhythm, pitch contour, intensity, articulation, and prosodic patterns.

The term “tempo” refers to a rate or speed of spoken language, including but not limited to the number of syllables or words produced per unit time and the temporal spacing between phonetic units, words, or phrases.

The term “prosody” refers to suprasegmental features of speech, including but not limited to intonation, stress, rhythm, pitch movement, and phrasing, which influence how an utterance is perceived.

The term “audio model processing unit” refers to a functional module implemented by execution of instructions on a processor, which is configured to process audio information, extract acoustic features, and learn models of speaking characteristics such as tempo and prosody.

The term “language processing unit” refers to a functional module implemented by execution of instructions on a processor, which is configured to analyze or generate natural language text, including the generation of response candidates to input inquiries.

The term “generative AI model” refers to a generative information processing model, typically implemented as a machine-learned parametric function such as a neural network, that is configured to generate output data, such as natural language text, in response to input data or prompt sentences.

The term “generative information processing model” refers to a machine-implemented model, including but not limited to a large-scale neural network, that is trained on data and configured to generate new information, such as sequences of tokens, based on input conditions.

The term “prompt sentence” refers to text data, including both instructions and context, provided as input to a generative AI model, which conditions or constrains the behavior of the model when generating output.

The term “prompt generation unit” refers to a functional module implemented by execution of instructions on a processor, which is configured to construct, modify, or select a prompt sentence based on inquiry content, related information, field-of-use information, user attribute information, and usage history information.

The term “inquiry content” refers to information representing a user's request or question, including but not limited to text-form queries or recognized speech transcripts, that is input to the system for obtaining a response.

The term “field-of-use information” refers to information indicating an application area, domain, or context in which the system is used, such as a technical field, business sector, or service category.

The term “user attribute information” refers to data associated with a user, including but not limited to age category, language preference, expertise level, accessibility requirements, or historical behavior patterns.

The term “usage history information” refers to data representing past interactions between users and the system, including but not limited to previous inquiries, responses, feedback, timestamps, and session identifiers.

The term “response candidate” refers to text-form data generated by a generative AI model or language processing unit, which expresses a possible answer or explanation to an inquiry before any optional post-processing or selection.

The term “speech parameters” refers to control values used by a speech synthesis or audio output subsystem, including but not limited to speaking rate, pitch, prosody pattern, pause positions, emphasis positions, and sound volume.

The term “pause position” refers to a location within a sequence of words or sentences where a temporal break or silence is to be inserted during speech output.

The term “emphasis position” refers to a location within a sequence of words or phrases where increased prominence, such as stronger stress or higher pitch, is to be applied during speech output.

The term “speech control information generation unit” refers to a functional module implemented by execution of instructions on a processor, which is configured to derive speech parameters and speech control information from response candidates, user attribute information, and learned speaking patterns.

The term “speech control information” refers to structured data that encodes how speech should be rendered, including but not limited to sentence segmentation, emphasis positions, timing of pauses, and prosodic contours.

The term “speech synthesis processing unit” refers to a functional module implemented by execution of instructions on a processor, which is configured to generate audio-form response data from text-form response candidates in accordance with speech parameters or speech control information.

The term “audio-form response data” refers to output data representing synthesized speech, including but not limited to digital audio waveforms or encoded audio streams suitable for playback by an audio output device.

The term “information management unit” refers to a functional module implemented by execution of instructions on a processor, which is configured to store, retrieve, update, and manage data such as inquiries, response candidates, speech parameters, user feedback, and usage histories, and to support learning and updating of models based on such data.

The term “user feedback” refers to information provided by a user evaluating the quality or appropriateness of a response or interaction, including but not limited to ratings, binary indicators, or free-form comments.

The term “learning and updating” refers to processes in which parameters or configurations of a generative AI model or audio model are modified based on data, including but not limited to supervised training, fine-tuning, or parameter adaptation.

The term “user interaction unit” refers to a functional module implemented by execution of instructions on a processor, which is configured to control user input acquisition, response presentation, and audio playback operations within a user interface.

The term “response display” refers to an operation in which generated response data is presented to a user in visual form, such as text shown on a display device or graphical user interface.

The term “audio playback control” refers to operations performed by a processor to start, stop, pause, resume, or otherwise manage the reproduction of audio-form response data through an audio output device.

The term “server” refers to a computing apparatus, which may include one or more processors, memories, and communication interfaces, configured to execute one or more of the audio model processing unit, language processing unit, prompt generation unit, speech control information generation unit, speech synthesis processing unit, information management unit, and user interaction unit.

In the following embodiments, a server, a terminal, and a user cooperate to implement the claimed invention. A hardware configuration and processing configuration are described in detail so that a person skilled in the art can implement the invention.

A server includes at least one processor, a memory, a storage device, and a communication interface. The server uses a general-purpose central processing unit and, in some embodiments, a graphics processing unit or a dedicated accelerator. The server executes software modules including an audio model processing unit, a language processing unit, a prompt generation unit, a speech control information generation unit, a speech synthesis processing unit, an information management unit, and a user interaction unit. The server stores executable programs and model parameters in a non-transitory computer-readable storage medium such as a magnetic disk, a solid-state drive, or a semiconductor memory.

A terminal includes at least one processor, a memory, a microphone, a speaker, a display, and a communication interface. The terminal executes an application program that communicates with the server, acquires user input, and outputs audio-form responses. The terminal may be a mobile device, a personal computer, a dedicated appliance, or an in-vehicle device.

A user operates the terminal to input inquiries, receives responses rendered as text and audio, and optionally provides feedback. The user may be a human operator in a customer support environment, an end user of a consumer product, or a professional in a specialized field.

### 1. Audio Model Processing

The server executes the audio model processing unit to model speaking characteristics based on audio information. The server acquires audio information from a storage device that holds a large-scale speech corpus. The audio corpus includes recordings of many speakers, including different ages, genders, accents, and emotional states, and covers various situations such as customer support, educational lectures, and medical consultations.

The server uses software libraries such as a numerical computation library and an audio processing library to perform signal processing on the audio information. The server converts each audio waveform into a sequence of acoustic feature vectors. The server, for example, computes mel-spectrograms, Mel-frequency cepstral coefficients, fundamental frequency contours, and energy values. The server normalizes these features and stores them in a tensor data structure.

The server executes a neural network configured as a sequence-to-sequence audio model. In one embodiment, the server uses a network structure similar to an encoder-decoder architecture with attention. The encoder receives a sequence of acoustic feature vectors and performs a series of linear transformations, convolution operations, and non-linear activation functions to produce an abstract representation of the input utterance. The decoder predicts prosodic parameters, including normalized tempo, pitch contours, and duration distributions for phonetic units. The server trains the audio model by minimizing a loss function that combines a mean squared error term for continuous parameters such as fundamental frequency and duration, and a cross-entropy term for categorical prosody labels such as emphasis classes. The server updates model weights using gradient descent with backpropagation. The server may perform data augmentation by altering speed, pitch, and noise conditions of input audio to increase robustness. Because the server learns generalized prosodic patterns from diverse speakers and contexts, the server can later infer prosody patterns suitable for new utterances, which improves speech naturalness and intelligibility beyond simple rule-based approaches.

The server stores learned model parameters in the storage device and exposes prosody inference functionality to other units. By performing this processing on the server-side hardware, the system uses optimized numerical operations and parallelism, achieving higher processing speed and consistency than manual design of prosody rules by a human.

### 2. Language Processing and Generative AI Model

The server executes the language processing unit to generate response candidates in text form. The server uses a generative AI model implemented as a large-scale neural network with an attention-based architecture. In one embodiment, the generative AI model includes multiple transformer layers, each composed of multi-head self-attention sub-layers and position-wise feed-forward sub-layers.

The server stores tokenized training data in a large text corpus. The corpus includes documents from multiple domains, such as technical manuals, frequently asked questions, support logs, news articles, and legal descriptions. The server applies a tokenization algorithm such as subword-based encoding to convert characters or words into token indices. The server embeds tokens into vector representations and processes them through the generative AI model.

The server trains or fine-tunes the generative AI model by minimizing a language modeling loss such as cross-entropy between predicted tokens and ground truth tokens. The server uses an optimization algorithm such as adaptive gradient methods to update model weights. The server may perform domain-specific fine-tuning by selecting subsets of documents from particular fields, such as finance or healthcare, and by adjusting hyperparameters such as learning rate and batch size.

Because the generative AI model is integrated with the prompt generation unit and the speech control information generation unit, the generative AI model is not merely performing generic text generation. The server constrains and shapes the generative AI model's outputs so that the generated response candidates have structures and styles optimized for subsequent speech synthesis and playback. This integration changes the internal scoring and decoding behavior by adjusting decoding parameters based on target audio characteristics, which improves the overall system performance.

### 3. Prompt Generation and Dynamic Control of the Generative AI Model

The server executes the prompt generation unit to construct a prompt sentence for the generative AI model. The server retrieves inquiry content, field-of-use information, user attribute information, and usage history information from the information management unit. The server also optionally retrieves related documents such as product descriptions, FAQ entries, and prior conversation segments.

The server composes the prompt sentence as a structured text that includes system-role instructions, contextual information, and the user's question. The server uses an internal data structure, for example a template object, to hold segments such as “Instruction,” “Context,” and “User question.” The server concatenates or formats these segments into a single text string suitable for input to the generative AI model.

The server, for example, constructs a prompt sentence such as:
System: You are an AI assistant for customer support of home appliances.
You must provide a natural, accurate, and easy-to-understand explanation.
Use polite and clear language suitable for being read aloud.
Context:
   Product: XYZ-1000 vacuum cleaner
   Related manual excerpt: [insert relevant manual text]
   FAQ: [insert relevant frequently asked questions]
User question:
Please explain how to use the automatic cleaning mode of the XYZ-1000 vacuum cleaner.
Instruction:
Generate a concise, step-by-step answer suitable for reading aloud,
with short sentences and clear structure, so that a TTS system
can synthesize it with a calm and friendly tone.

In another example, the server constructs a prompt sentence that emphasizes domain-specific terminology and explanation level:
Instruction: You are a customer support agent for home appliance maintenance.
Use domain-appropriate terminology, but explain each technical term
in simple words that a non-expert can understand.
Provide a step-by-step guide where possible.
User question:
Provide a detailed and easy-to-understand explanation of how to clean
and maintain the filter of the automatic cleaning mode.

In another example, the server constructs a prompt sentence that explicitly optimizes for older listeners:
Instruction: Generate an answer that is suitable for text-to-speech for an elderly user.
Use short sentences, speak slowly, avoid complex clauses,
and make sure each operation step is clearly separated.
User question:
Please tell me how to operate the remote control and start the cleaning mode.

The server selects or generates such prompt sentences using rules and learned mappings that take into account user attributes and field-of-use. The server may, for example, store a table that associates combinations of field-of-use and user attribute values with specific instruction phrases, maximum sentence lengths, and allowed technical term density. By controlling the prompt sentence composition in this way, the server alters the generative AI model's internal attention behavior and decoding path, so that the output text is less likely to contain long, convoluted sentences and more likely to be segmented into speech-friendly units.

This structure-specific control is not a mere automation of a human drafting task; rather, it exploits the non-linear behavior of the generative AI model to adjust its probability distribution over output sequences in a systematic, processor-controlled manner. As a result, the server reduces the burden on the speech synthesis subsystems and improves overall system latency and intelligibility.

### 4. Speech Control Information Generation

The server executes the speech control information generation unit to derive speech parameters and speech control information from the response candidates and user attributes. The server parses each response candidate into sentences and clauses using a syntactic analysis algorithm or pattern-based segmentation. The server assigns pause positions between logical units such as sentence ends and step numbers. The server determines emphasis positions on words that indicate key operations or warnings.

The server uses the patterns of tempo and prosody learned from the audio model processing unit to map textual structures to numeric parameters. For example, the server assigns a slower speaking rate and longer pauses for responses intended for elderly or novice users, and a faster speaking rate and more neutral prosody for users identified as experts. The server computes a vector representation of speech parameters, including numeric values for speaking rate, pitch scaling, duration scaling, and emphasis weights at specific token positions.

The server outputs speech control information in an internal data structure that couples the text tokens with associated prosody parameters. The server may represent this information as a sequence of frames, each including a token identifier, an estimated duration, a pitch target, and an emphasis flag. This explicit mapping between text and control parameters allows the speech synthesis processing unit to generate audio-form responses that closely follow the intended prosodic design.

Because the speech control information generation unit uses learned prosody patterns and user attributes in combination, the unit provides an algorithmic control mechanism that is difficult to achieve by simple hand-crafted rules. The server thereby reduces prosody errors such as unnatural pitch jumps, overly long pauses, or monotonous speech, which leads to lower cognitive load on listeners and improved comprehension.

### 5. Speech Synthesis and Audio Output

The server or, in some embodiments, the terminal executes the speech synthesis processing unit to generate audio-form response data. The server receives response text and speech control information. The server converts text to a phonetic or grapheme sequence and aligns it with the prosody parameters. The server uses a neural vocoder or another waveform generation model, which may include a stack of convolutional layers or recurrent layers configured to predict waveform samples from acoustic feature sequences.

The server generates a mel-spectrogram or another spectral representation from the text and prosody parameters, and the waveform generation model converts this representation into an audio waveform. The server can leverage hardware acceleration on a graphics processing unit to quickly perform the convolution and upsampling operations required by the neural vocoder.

The terminal receives the synthesized audio-form response data through the communication interface, or in another embodiment, the terminal locally executes a lightweight speech synthesis model that uses the speech control information. The terminal outputs the resulting audio through the speaker. The terminal also displays the text response on the display and allows the user to control playback, such as pausing or replaying the audio.

In this way, the system does not simply convert arbitrary text to speech. The system uses carefully generated response candidates and speech control information to produce speech that is optimized for the specific user and context, which improves technical performance indicators such as intelligibility and speech naturalness.

### 6. Information Management and Model Updating

The server executes the information management unit to store inquiries, response candidates, speech parameters, user feedback, and usage histories. The server uses a structured data schema that includes fields such as user identifiers, timestamps, domain labels, prompt content, generated responses, prosody parameters, and feedback metrics.

The server periodically analyzes aggregated data to identify patterns such as frequent failure types, typical user preferences, and performance bottlenecks. The server uses this analysis to adjust prompt templates, decoding parameters, and training datasets. The server re-trains or fine-tunes the generative AI model and the audio model by sampling from stored usage history data and feedback-labeled examples.

The server, for instance, identifies cases where users repeatedly replay certain parts of the response or provide negative feedback indicating difficulty in understanding. The server labels such segments as problematic examples and adjusts the training dataset to emphasize simpler sentence structures or slower speaking rates for similar contexts. This feedback loop allows the system to improve its performance over time in a way that is tightly coupled to the underlying model parameters and decoding strategies, not merely by adjusting superficial user interface options.

### 7. Technical Effects and Improvement of Computer Technology

The server improves computer technology in several respects. First, the server reduces the computational burden of the speech synthesis stage by steering the generative AI model toward speech-friendly outputs through controlled prompt generation. Because the generated responses are already segmented into short sentences and contain explicit step numbering, the speech synthesis processing unit can use simpler alignment algorithms and requires fewer re-processing passes, which reduces processing time and memory usage.

Second, the server improves accuracy and robustness of audio output by employing the audio model processing unit to learn prosody from large corpora and by applying speech control information that is customized to user attributes. This reduces perceptual errors and miscommunication caused by unnatural prosody. The combination of learned prosody patterns with dynamic user-specific parameterization is not a mere automation of human editing; rather, it modifies the internal numeric behavior of models and optimizes them for real-time execution on digital hardware.

Third, the server improves data management efficiency and prediction quality by using integrated storage and analysis of inquiries, responses, speech parameters, and feedback. This integrated approach creates a closed feedback loop in which model updating is directly informed by real-world interaction data and error patterns. The server uses optimized data structures and retrieval methods so that the extra analysis load does not introduce latency into the online interaction.

Fourth, the server improves communication efficiency and reduces network load in some embodiments by performing model inference and prosody determination on the server and transmitting compact speech parameters or compressed audio rather than raw or verbose intermediate representations. For example, the server may send a compact prosody control sequence and short text instead of long audio streams when the terminal performs local synthesis, or the server may compress generated audio using an efficient codec.

Because these improvements rely on structured interaction between model architectures, data structures, and hardware operations, the system provides a technical solution that enhances the functioning of a computer-based dialog platform. The system is not limited to automating a human operator's work; instead, the system reconfigures the internal computational workflow, including prompt construction, sequence decoding, prosody generation, and feedback-driven training, so as to achieve technical advantages in speed, accuracy, and resource utilization.

### 8. Variations and Alternative Embodiments

The server may adopt different neural network architectures for the generative AI model, such as transformer decoders with different numbers of layers, recurrent neural networks, or hybrid architectures. The server may vary tokenization schemes, such as character-level, word-level, or mixed granularities, depending on language and domain requirements.

The server may implement the audio model processing unit as a separate module or as part of a multi-task model that jointly learns text-to-speech and speech-to-text mapping. The server may adopt different loss functions or regularization techniques, such as sequence-level adversarial training or scheduled sampling, to further improve stability and quality.

The terminal may perform more or less of the processing depending on hardware capabilities. In a low-resource terminal, the server may handle most of the inference workload and send compressed audio-form responses. In a high-performance terminal, the server may send only response text and speech parameters, and the terminal may perform local synthesis to reduce network usage and latency.

The user interface may differ by application, but the underlying functions-input acquisition, response display, audio playback, and feedback acquisition-remain within the user interaction unit so that the core technical processing described above is preserved. By adjusting modules and parameters within the framework described here, a person skilled in the art can implement the invention in diverse environments such as customer service centers, educational tutors, in-vehicle voice assistants, or healthcare triage systems, while maintaining the technical effects of improved speech-friendly generation, prosody control, and adaptive model updating.

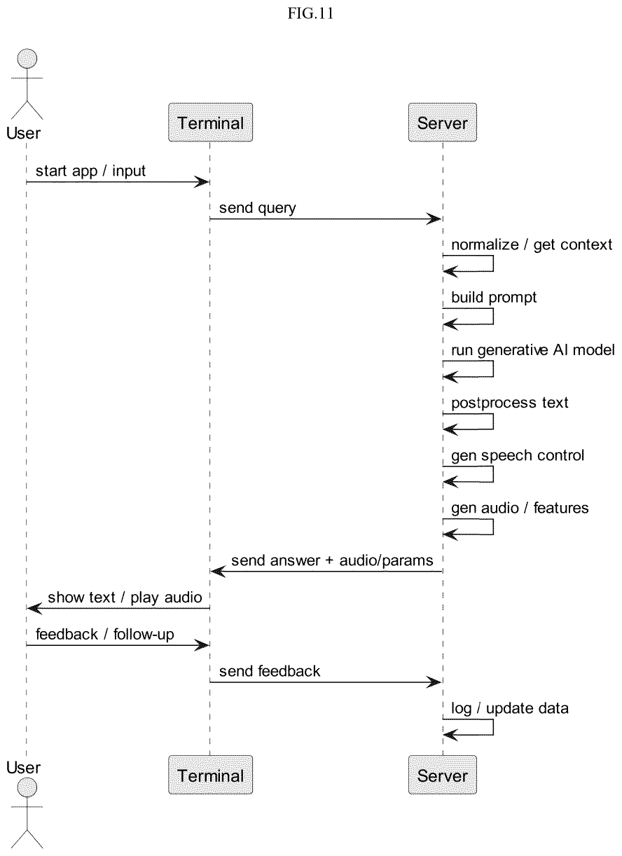

The following describes the processing flow using FIG. 11.

### Step 1:

The user operates the terminal to start an application and select an input mode.

The terminal receives, as input, a user action such as tapping a “voice input” button or a “text input” field. Based on this input, the terminal reads configuration data from local storage, including preferred language, speaking rate, and voice tone, and initializes user interface components on the display. The terminal outputs an updated interface state that indicates the selected input mode and prepares internal buffers for capturing text or audio.

### Step 2:

The user provides an inquiry using voice or text.

In a voice input case, the terminal receives, as input, acoustic signals from the microphone when the user speaks a question, for example “Please explain how to use the automatic cleaning mode.” The terminal samples the microphone signal as digital audio frames, applies analog-to-digital conversion, and stores the audio frames in memory. The terminal may optionally apply noise reduction and voice activity detection to trim silence. The terminal outputs a sequence of cleaned audio frames or an intermediate audio buffer.

In a text input case, the terminal receives, as input, key events or touch input corresponding to characters typed by the user. The terminal concatenates these characters into a text string, validates that the string is non-empty, and stores the text in an input field. The terminal outputs the complete inquiry text.

### Step 3:

The terminal prepares a request payload and transmits the inquiry to the server.

The terminal receives, as input, either the cleaned audio frames or the text string representing the user's inquiry, along with current user settings. The terminal, in the audio case, either attaches the audio frames or performs local speech recognition to convert the audio into text. The terminal then constructs a request object that includes the inquiry text, user attribute information, language setting, and a domain label such as “customer_support.” The terminal serializes this object into a message format and outputs a network request, which it sends to the server via a communication interface using a secure protocol.

### Step 4:

The server receives the request and normalizes the inquiry data.

The server receives, as input, the network request containing the inquiry text and associated metadata. The server parses the message, verifies authentication tokens, and records a log entry in the information management unit. The server performs text normalization, including lowercasing (where appropriate), removal of control characters, and standardization of punctuation. The server also maps domain and user attributes into internal identifiers. The server outputs a normalized inquiry object that is ready for prompt construction and language processing.

### Step 5:

The server retrieves related contextual information from storage.

The server receives, as input, the normalized inquiry object with domain and user identifiers. The server issues database queries to the information management unit to retrieve related documents, such as product descriptions, frequently asked questions, and prior conversation segments for the same user or the same domain. The server may also retrieve usage history entries that contain past feedback for similar inquiries. The server performs data filtering, ranking, and selection to choose the most relevant snippets, for example by computing similarity scores between the inquiry text and stored documents. The server outputs a context package that includes selected manual excerpts, FAQ entries, and relevant history.

### Step 6:

The server constructs a prompt sentence for the generative AI model.

The server receives, as input, the normalized inquiry object and the context package. The server applies prompt generation rules that depend on the field-of-use and user attributes, such as maximum sentence length or desired politeness level. The server fills a prompt template with: (i) an instruction section describing the required style and structure of the answer, (ii) a context section embedding relevant manual and FAQ snippets, and (iii) a user question section containing the normalized inquiry text. The server concatenates these sections with appropriate separators to form a single prompt sentence or prompt text. The server outputs this prompt text as a string prepared for tokenization.

### Step 7:

The server tokenizes the prompt and runs the generative AI model.

The server receives, as input, the constructed prompt text. The server uses a tokenizer to convert the prompt text into a sequence of token identifiers. The server maps each token identifier to an embedding vector and feeds the sequence into the generative AI model implemented as a multi-layer neural network. The server performs matrix multiplications, attention computations, and non-linear transformations across model layers to propagate the signal and compute output logits for each potential next token. The server applies a decoding algorithm, such as greedy decoding or top-k sampling with temperature control, to iteratively select output tokens and build a response sequence. The server outputs a candidate response text by converting the generated token sequence back into characters and words.

### Step 8:

The server post-processes the generated response text for speech suitability.

The server receives, as input, the raw response text from the generative AI model. The server applies formatting operations such as ensuring that sentences are properly terminated, adding numbering for step-by-step instructions, and splitting overly long sentences at appropriate conjunctions. The server may also enforce constraints from the user attributes, such as limiting sentence length or simplifying vocabulary. The server then stores the finalized response candidate in the information management unit for logging. The server outputs a speech-friendly response text.

### Step 9:

The server generates speech control information including prosody and timing.

The server receives, as input, the speech-friendly response text and the user attribute information.

The server first segments the response text into sentences and clauses using syntactic rules or a segmentation algorithm. The server then accesses the audio model processing unit, which has learned tempo and prosody patterns. Based on the segmentation structure and the learned patterns, the server computes speech parameters such as speaking rate, pitch contour shapes, and default pause durations at sentence boundaries. The server adjusts these parameters according to user attributes; for example, the server reduces speaking rate and increases pause duration for elderly users. The server outputs speech control information, which contains a mapping between text positions and numeric prosody parameters such as duration factors, pitch scaling factors, and emphasis flags.

### Step 10:

The server generates audio-form response data or speech-oriented acoustic features.

The server receives, as input, the finalized response text and the speech control information. The server converts the text into a phoneme or grapheme sequence using a text-to-phoneme conversion procedure. The server aligns each phoneme with its corresponding prosody parameters from the speech control information. The server then computes an acoustic representation, such as a mel-spectrogram, by passing the aligned sequence through an acoustic model that predicts spectral and prosodic values frame-by-frame. The server, in embodiments where it performs waveform synthesis, further processes the acoustic representation using a neural vocoder to generate a digital audio waveform. The server outputs either synthesized audio data or intermediate acoustic features, depending on whether speech synthesis is completed server-side or deferred to the terminal.

### Step 11:

The server packages the response and sends it to the terminal.

The server receives, as input, the speech-friendly response text, the speech control information, and either the synthesized audio data or the acoustic features. The server constructs a response message that includes the text answer, selected speech parameters or audio data, a conversation identifier, and relevant metadata such as model version. The server serializes this message into a network format and sends it via the communication interface to the terminal. The server outputs a network response that carries all necessary information for the terminal to present and/or play the answer.

### Step 12:

The terminal receives the response and prepares display and audio output.

The terminal receives, as input, the network response from the server. The terminal parses the message to extract the text answer, speech parameters, and either complete audio data or acoustic features. The terminal updates its user interface to show the response text in a chat view or dialog box. If the terminal receives only acoustic features and prosody parameters, the terminal invokes a local text-to-speech engine to synthesize the waveform using the provided control information.

If the terminal receives ready-to-play audio data, the terminal loads the audio into an audio buffer. The terminal outputs a prepared visual display and an audio buffer ready for playback.

### Step 13:

The terminal plays back the audio and allows user control.

The terminal receives, as input, user settings for playback, such as volume level and whether auto-play is enabled, along with the audio buffer prepared in the previous step. The terminal uses the operating system's audio subsystem to send the audio samples to the digital-to-analog converter connected to the speaker. The terminal updates the display to present playback controls, including pause, resume, and replay buttons. The terminal outputs audible speech corresponding to the response text and a user interface state that reflects current playback status.

### Step 14:

The user listens to the response and optionally provides feedback or a follow-up inquiry.

The user receives, as input, the spoken and displayed response. The user evaluates clarity, correctness, and speaking style. If the user chooses to provide feedback, the user interacts with feedback controls such as “helpful” or “not helpful” buttons or a text comment field. If the user wants more information, the user inputs a follow-up question through voice or text as in the initial steps. The user's actions output new input events that the terminal captures for further processing.

### Step 15:

The terminal sends feedback and follow-up data to the server for logging and improvement.

The terminal receives, as input, user feedback selections and any follow-up inquiries. The terminal associates these with the conversation identifier from the previous server response. The terminal constructs a feedback message that includes the rating or comment, the original inquiry, the response text, and possibly usage metrics such as replay count. The terminal transmits this feedback to the server via the communication interface. The terminal outputs a structured feedback request.

### Step 16:

The server updates stored records and supports model refinement.

The server receives, as input, the feedback request and any follow-up inquiries. The server adds or updates entries in the information management unit, storing the feedback linked to the specific response candidate, speech parameters, and prompt sentence used. The server may aggregate such feedback across many interactions and compute statistics, such as error rates for particular templates or prosody profiles. The server outputs updated data sets that serve as training or fine-tuning material for future retraining of the generative AI model and audio models, thereby closing the loop between online behavior and offline model improvement.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialogue systems and care-support systems often handle speech recognition, language understanding, response generation, and output control as isolated components that are loosely coupled and heuristically tuned. As a result, such systems suffer from several technical limitations. First, acoustic modeling typically focuses on generic recognition accuracy and does not construct or exploit per-speaker acoustic profiles that capture tempo, prosody, and listening characteristics. This leads to suboptimal speech decoding for elderly or impaired speakers and yields synthesized audio that is difficult for such users to understand. Second, language processing units commonly generate responses directly from a user query and static domain data, without using a systematically constructed, structured context or dynamically optimized prompt sentences tailored to a generative AI model. Consequently, the utilization efficiency of large generative models is low, response behavior is unstable, and fine-grained per-user adaptation of response style is difficult to control at the system level. Third, conventional systems store conversational logs only as unstructured text, without recording the relationship among user inquiries, constructed prompts, contextual data, and generated responses. This prevents the system from algorithmically updating prompt-generation policies and expression styles based on actual interaction performance. Fourth, even when care-related biometric data and activity data are collected, anomaly detection logic and explanatory message generation for caregivers are often implemented as separate rule sets, not as an integrated workflow in which health data streams are directly fed, via well-structured prompt sentences, into a generative model. As a result, anomaly alerts tend to be either too noisy or uninformative, and the computing resources of the generative model are not effectively harnessed for real-time summarization of health trends. Fifth, feedback from terminal devices regarding comprehensibility or suitability of responses is rarely used to formally adjust constraints on wording, length, or vocabulary at the prompt-construction layer, so the system cannot systematically improve the behavior of the generative model over time for each individual user. Accordingly, there is a need for an improved computer-implemented system and server architecture that (i) builds and maintains per-speaker acoustic models, (ii) constructs and updates structured context and prompt sentences as first-class computational objects, (iii) integrates a generative AI model into closed-loop interaction cycles using stored interaction and health data, and (iv) adaptively optimizes response style and output characteristics on a per-user basis, thereby improving the technical operation of the speech and language processing pipeline itself.

The specific processing by the specific processing unit 290 of the data processing device 12 in Application Example 1 is realized by the following means.

The present invention provides a server comprising a processor configured to learn acoustic characteristics including speech tempo and prosody for each speaker based on acoustic information, and to generate speaker-specific acoustic model information; to interpret a natural language inquiry sentence obtained from the speaker based on state information and management information associated with the speaker, and to identify a type of the inquiry and target information; to acquire, in accordance with the identified type of the inquiry and the target information, schedule information, intake information, nutrition information, state index information, and history information stored in a management information storage unit, and to generate structured context information based on the acquired information; to generate a prompt sentence including the inquiry sentence and the structured context information, to input the prompt sentence to a generative language model, and to cause the generative language model to generate a natural language response sentence according to attributes and preferences of the speaker; to convert the natural language response sentence into acoustic response information in which speech rate, volume, and voice quality are adjusted based on the acoustic model information of the speaker and listening characteristic information of the speaker; to record the inquiry sentence, the prompt sentence, the natural language response sentence, and the structured context information in association with each other in time series, and to update at least one of generation conditions of the prompt sentence and an expression style of the natural language response sentence based on recorded information; to continuously acquire state index information relating to the speaker including biometric information and activity information, to calculate an abnormality index based on transitions of the biometric information and the activity information, and, when the abnormality index satisfies a predetermined condition, to transmit alert information to a caregiver terminal and to input, to the generative language model, a prompt sentence including the transitions of the biometric information and management conditions so as to cause the generative language model to generate an explanatory natural language sentence for a caregiver and to add the explanatory natural language sentence to the alert information; and to evaluate comprehensibility or suitability of the natural language response sentence based on evaluation information acquired from a terminal device, and, in accordance with an evaluation result, to update at least one of expression constraint information, sentence length control information, and vocabulary control information included in a prompt sentence to be input to the generative language model, thereby adaptively optimizing, for each speaker, an expression style of natural language response sentences generated thereafter. This enables an integrated improvement of computer operation in a speech and language processing system, by tightly coupling per-speaker acoustic modeling with structured context construction and prompt-based control of a generative AI model, by automatically refining prompt-generation policies and response expression styles based on logged interaction and health data, and by dynamically adapting audio and textual outputs to individual users, thereby enhancing recognition robustness, response stability, and output intelligibility in a technically grounded manner.

The term “acoustic information” refers to digital data representing sound, including but not limited to raw audio waveforms, encoded audio signals, and derived acoustic feature values obtained from such signals.

The term “speaker” refers to a human user who provides spoken input to the system and for whom the system generates corresponding responses.

The term “acoustic characteristics” refers to measurable properties of a speaker's voice, including at least speech tempo, prosody, pitch, intensity, and spectral features, that can be modeled and used for analysis or synthesis.

The term “speech tempo” refers to a rate at which a speaker produces speech, including quantities such as syllables, morphemes, or words per unit time, as determined from acoustic information.

The term “prosody” refers to suprasegmental features of speech, including intonation, stress patterns, rhythm, and pauses, as expressed in the acoustic information.

The term “speaker-specific acoustic model information” refers to data structures, parameters, or models that represent acoustic characteristics of an individual speaker and are used to process or generate speech tailored to that speaker.

The term “natural language inquiry sentence” refers to a sequence of linguistic units in a human language that expresses a request, question, or command provided by the speaker.

The term “state information” refers to information indicating a current or recent condition associated with a speaker, including but not limited to health-related indices, activity status, emotional indicators, or environmental context.

The term “management information” refers to structured data managed by the system for a speaker, including schedule information, intake information, nutrition information, state index information, history information, and configuration or preference settings.

The term “type of the inquiry” refers to a classification label or category indicating a functional purpose of a natural language inquiry sentence, such as a request for schedule information, medication timing, menu content, or health-related explanation.

The term “target information” refers to specific subject matter, entities, or attributes to which a natural language inquiry sentence is directed, such as a particular date, time, event, medication, or measurement.

The term “schedule information” refers to data describing planned or recorded events associated with a speaker, including start times, end times, event types, and related annotations.

The term “intake information” refers to data representing consumption-related events of a speaker, including ingestion of food, beverages, or substances such as medications, together with associated timing and quantity information.

The term “nutrition information” refers to data describing nutritional properties of food or intake items, including categories such as caloric value, macronutrients, micronutrients, and dietary restrictions.

The term “state index information” refers to numerical or categorical indicators representing a condition or trend associated with a speaker, including biometric indices, activity indices, or composite scores derived from underlying measurements.

The term “history information” refers to time-series records of past events or interactions related to a speaker, including prior inquiries, responses, health measurements, schedules, and system actions.

The term “management information storage unit” refers to a hardware and software combination, such as a memory device and a database management component, configured to store and provide management information for processing by the processor.

The term “context information” refers to structured data derived from management information and related sources that is associated with a natural language inquiry sentence and used to assist generation of a response.

The term “structured context information” refers to context information that is arranged in a predetermined, machine-readable format, such as key-value pairs, tables, or labeled fields, suitable for use in prompt construction and model input.

The term “prompt sentence” refers to a textual input string or set of textual instructions that includes at least a natural language inquiry sentence and context information, and that is provided to a generative language model to control its output behavior.

The term “generative language model” refers to a parametrized computational model configured to generate natural language text by predicting sequences of linguistic units conditioned on input text such as a prompt sentence.

The term “natural language response sentence” refers to a sequence of linguistic units in a human language generated by the generative language model for output to the speaker in response to an inquiry.

The term “attributes of the speaker” refers to properties associated with a speaker, including but not limited to age group, language, dialect, health condition, and cognitive or sensory characteristics.

The term “preferences of the speaker” refers to configurable or learned settings indicating desired characteristics of responses for a speaker, including tone, politeness level, detail level, and preferred answer length.

The term “acoustic response information” refers to digital data representing audio suitable for output to a speaker, obtained by converting a natural language response sentence into synthesized speech.

The term “listening characteristic information” refers to information indicating how a speaker receives audio, including hearing ability, preferred volume, preferred speech rate, and device output constraints.

The term “generation conditions of the prompt sentence” refers to rules, parameters, or templates that determine how a prompt sentence is constructed, including inclusion of context elements, safety constraints, tone instructions, and length controls.

The term “expression style of the natural language response sentence” refers to stylistic properties of generated text, including politeness level, complexity, sentence length, vocabulary selection, and discourse structure.

The term “time series” refers to a temporal sequence of data items, each associated with at least one time index, representing the order and timing of occurrences.

The term “state index information relating to the speaker” refers to state index information whose value is associated with a specific speaker and that may change over time according to the speaker's condition or behavior.

The term “biometric information” refers to measurements or indicators obtained from or about a speaker's body, including blood pressure, heart rate, temperature, oxygen saturation, and similar physiological parameters.

The term “activity information” refers to data representing physical or behavioral activities of a speaker, including movement levels, exercise sessions, sleep patterns, or daily living actions.

The term “abnormality index” refers to a calculated indicator that quantifies a degree of deviation of biometric information and activity information from a reference or normal state.

The term “predetermined condition” refers to one or more threshold rules or logical expressions that, when satisfied by the abnormality index, trigger a specific system action such as alert transmission.

The term “alert information” refers to data representing a notification of a detected abnormality or noteworthy event, including at least an indication of the event, a time, and optionally supplementary explanation.

The term “caregiver terminal” refers to an information processing device operated by a caregiver or manager that is configured to receive and present alert information and explanatory information.

The term “management conditions” refers to parameters, policies, or constraints relating to supervision or care of a speaker, such as target ranges for biometric values, monitoring intervals, and escalation rules.

The term “explanatory natural language sentence for a caregiver” refers to a natural language response sentence generated for presentation to a caregiver and describing, summarizing, or contextualizing data such as health trends or anomalies.

The term “evaluation information” refers to data received from a terminal device indicating a quality assessment of a natural language response sentence, such as ratings of comprehensibility or suitability.

The term “expression constraint information” refers to configuration information that constrains characteristics of generated text, including allowed or disallowed types of expressions, politeness levels, and tone guidelines.

The term “sentence length control information” refers to configuration information that constrains or influences lengths of generated sentences or responses, including maximum or minimum lengths or desired ranges.

The term “vocabulary control information” refers to configuration information that constrains or influences word choices in generated text, such as preferred vocabulary sets, prohibited terms, or simplification requirements.

In one embodiment, a server cooperates with one or more terminal devices and users to implement the claimed system. The server includes at least one processor, a main memory, a non-volatile storage device, a network interface, and optionally a hardware accelerator such as a graphics processing unit. The terminal includes at least one processor, a memory, an audio input device, an audio output device, a display, and a user input device such as a touchscreen.

The server executes an operating system such as a general-purpose server operating system and a set of application programs implementing an acoustic modeling module, a language processing module, a generative AI model interface module, a text-to-speech module, and a data management module. The terminal executes an operating system such as a mobile operating system and a client application program implementing user interaction, audio capture, and audio playback.

The terminal acquires acoustic information from the user through the audio input device. The terminal digitizes speech signals into audio samples, stores the audio samples in a buffer in memory, and transmits the buffered audio samples to the server through the network interface using a communication protocol such as HTTPS. The terminal further receives acoustic response information and natural language response sentences from the server and outputs the acoustic response information through the audio output device while presenting the natural language response sentences on the display.

The server receives the acoustic information and stores the acoustic information in a memory region associated with a speaker identifier. The server uses an acoustic modeling module implemented in software, for example using a numerical computation framework, to convert the acoustic information into acoustic features. The server computes short-time Fourier transforms of the audio samples, derives mel-spectrograms and mel-frequency cepstral coefficients, and further extracts pitch and energy contours. The server normalizes the acoustic features over time to reduce channel variability and background noise.

The server uses a neural network that constitutes a per-speaker acoustic model. In one example, the server uses a neural network having a convolutional front-end followed by a recurrent or transformer-based sequence encoder, trained to output phonetic states and prosodic parameters. The server stores weights of this neural network as speaker-specific acoustic model information in a data structure indexed by a speaker identifier. The server updates the speaker-specific acoustic model information by performing further training or adaptation using newly received acoustic information. The server adjusts the learning rate and regularization parameters to avoid overfitting to short-term noise. In this way, the server learns acoustic characteristics including speech tempo and prosody for each speaker and generates and maintains a dedicated set of acoustic model parameters for each speaker.

The server aggregates tempo statistics such as average syllables per second and pause duration distributions and prosody statistics such as pitch range and typical intonation contours and stores these statistics together with the acoustic model parameters as part of the speaker-specific acoustic model information. The server uses these statistics to improve recognition robustness for elderly or impaired speakers by adjusting decoding beam widths and timing models in the speech recognition process.

The server interprets a natural language inquiry sentence by first performing automatic speech recognition to convert the acoustic information into a text representation. The server uses the speaker-specific acoustic model information to guide decoding of phonetic units and to align predicted phonetic sequences to lexical units in a pronunciation lexicon. By using individualized tempo and prosody parameters in the decoding process, the server reduces insertion and deletion errors typically caused by slow or irregular speech, thus improving recognition accuracy.

The server then applies a language understanding component, for example a sequence classifier based on a transformer encoder, to the text to derive an intent label corresponding to a type of the inquiry and to extract entities corresponding to target information. The server accesses a state information storage area and a management information storage unit that collectively hold data structures representing state information, schedule information, intake information, nutrition information, state index information, history information, and user preferences. The server retrieves records associated with the speaker identifier, for example daily schedule entries, medication intake times, nutritional properties of menu items, recent biometric readings, and previous inquiries and responses.

The server constructs context information by organizing the retrieved records into a structured representation. In one embodiment, the server maps each type of information to a predefined set of fields. For example, schedule information is mapped to fields including event type, start time, end time, and description; intake information is mapped to fields including item type, quantity, and timing; state index information is mapped to fields including measurement type, value, timestamp, and reference range. The server combines these field-based records into a context object that preserves the relationships among data types. This structured context information enables the server to deterministically control which data is exposed to the generative AI model and in what order.

The server generates a prompt sentence that embeds the natural language inquiry sentence and selected parts of the structured context information into a textual instruction for the generative AI model. The server uses prompt-generation rules that specify, for each type of inquiry and each type of speaker attribute, which context fields must be included, in which language the instruction must be written, what tone constraints must be described, and what safety restrictions must be imposed. For example, the server may generate a prompt sentence as:
“Using only the care data provided below (menus, medications, schedules, allergies, vitals), generate a concise and accurate answer in polite English suitable for an elderly user. Do not invent data that is not provided.
Question: “What is today's lunch?”
Menu: “Braised fish and stewed vegetables”
Allergy: “Shrimp allergy”
User preference: “Brief and gentle wording”

In another example for a symptom-related question, the server may generate a prompt sentence as:
“Answer the following question in English with a reassuring but non-diagnostic message. Do not provide a medical diagnosis; instead, recommend contacting a caregiver or medical staff when appropriate.
Question: “I have a bit of a headache. Should I be concerned?”
Recent vitals: systolic 160, diastolic 100, usual 130/80.”

The server inputs the prompt sentence to a generative AI model. In one embodiment, the server uses a transformer-based generative language model with multiple self-attention layers and feedforward layers, parameterized by a large number of weights stored in memory. The server tokenizes the prompt sentence using a subword tokenizer and converts the tokens into embeddings. The generative AI model computes attention weights over the sequence of tokens to form contextualized representations and predicts subsequent tokens by applying a softmax function over an output vocabulary at each generation step.

The server configures the generative AI model with generation parameters such as maximum output length, temperature, and top-k or top-p sampling thresholds to control diversity and determinism. The server obtains a natural language response sentence as a sequence of tokens decoded into text. The server post-processes the text to ensure compliance with required politeness levels and safety rules. The server may enforce forbidden words and required disclaimers through additional filtering and re-generation if necessary.

The server converts the natural language response sentence into acoustic response information using a text-to-speech module. In one implementation, the server uses a neural text-to-speech architecture comprising an encoder that converts text into phoneme sequences and a decoder that produces mel-spectrograms, followed by a neural vocoder that generates waveforms. The server inputs the speaker-specific acoustic model information, including tempo and prosody parameters, and listening characteristic information, including preferred speech rate and volume, into the text-to-speech module. The server modifies duration prediction and prosody control layers to match the speaker's preferred or required tempo and intonation. The server adjusts amplitude scaling to meet a target volume level encoded in the listening characteristic information. As a result, the synthesized speech is tailored to the speaker's hearing and comprehension abilities, improving intelligibility and reducing listening effort.

The server records the natural language inquiry sentence, the generated prompt sentence, the natural language response sentence, and the structured context information in association with each other in a time series. The server stores these records in a database where each entry includes fields such as speaker identifier, timestamp, inquiry text, prompt template identifier, included context fields, generated response text, and evaluation status. The server uses this time-series record to analyze how different prompt-generation rules and context selections affect response quality and user satisfaction.

The server continuously acquires state index information relating to the speaker, including biometric information and activity information, from sensors, caregiver inputs, or other subsystems. The server stores these values in time-stamped records and computes derived metrics such as moving averages and trend slopes. The server calculates an abnormality index using a predetermined function that compares current and historical biometric values with reference ranges. The function may use a weighted combination of deviations and rate-of-change values. When the abnormality index exceeds a predetermined threshold or satisfies a logical condition, the server generates alert information, including a type of abnormality and relevant measurements, and transmits the alert information to a caregiver terminal.

The server also constructs a prompt sentence for the generative AI model that includes the transitions of the biometric information and management conditions, such as:
“Summarize the following blood pressure trend in English for a caregiver. Highlight that the patient's blood pressure is higher than usual, and recommend that the patient be checked soon, without giving a diagnosis.
Trend: usual 130/80, recent three readings 155/95, 160/100, 158/98.”

The server inputs this prompt sentence to the generative AI model and obtains an explanatory natural language sentence for the caregiver. The server appends this explanatory sentence to the alert information and transmits the combined content to the caregiver terminal for display. This integrated process enables the server to convert raw biometric time series into concise, interpretable guidance while maintaining a clear separation between numerical anomaly detection and language formatting.

The server evaluates the comprehensibility or suitability of the natural language response sentence based on evaluation information acquired from the terminal. The terminal presents rating options, for example “easy to understand” or “hard to understand,” and transmits selected ratings to the server. The server aggregates these ratings per speaker and per prompt template. When the server detects that certain prompt templates or response patterns are consistently rated as hard to understand, the server updates expression constraint information, sentence length control information, and vocabulary control information. For example, the server may reduce a maximum allowed sentence length, restrict use of technical terms, and require explicit connective phrases. The server then incorporates these updated constraints into subsequent prompt-generation rules, thereby adaptively optimizing the expression style of the generated responses for each speaker over time.

The server improves computer technology by treating prompt sentences, context structures, and acoustic model parameters as explicit computational artifacts that are automatically adapted using logged interaction data and feedback. Unlike a mere automation of human conversation, the server introduces non-conventional processing steps at the system level: the server constructs structured context information with a defined schema and uses that information to deterministically control the generative AI model's input; the server records prompt-generation parameters and resulting responses in a machine-readable time series and uses that record to algorithmically update future prompts. These operations result in improved computational efficiency because the generative AI model receives only relevant, structured context, reducing unnecessary token length and inference cost. The operations also produce improved accuracy and stability of responses, because the prompt-generation process is optimized empirically and explicitly rather than through ad hoc manual tuning.

The server also achieves technical effects in the acoustic domain. By maintaining speaker-specific acoustic model information and adjusting decoding parameters based on tempo and prosody statistics, the server reduces recognition errors for non-standard speech, which in turn reduces the number of communication retries and network transmissions. Similarly, by using listening characteristic information to adjust synthesized speech characteristics, the server reduces listening errors and the need for repeated playback, thereby reducing processing load on both the server and the terminal and improving energy efficiency at the device level.

The server employs a learning method that uses a loss function combining cross-entropy for phonetic or textual output with auxiliary penalties on prosody deviation and tempo mismatch. The server updates weights of the acoustic model and, in some embodiments, adapter layers of the generative AI model using gradient-based optimization. The server may augment training data by performing time-stretching, pitch-shifting, and noise-injection transformations on acoustic information and by paraphrasing text content through controlled synonym replacement. These procedures create robust models that maintain performance across variable conditions typical of elderly users.

The server can be implemented in different configurations. In one variation, the generative language model executes on the same physical server as the acoustic modeling and data management modules. In another variation, the generative language model executes on a separate compute node or external service, and the server communicates with the generative language model via an application programming interface. In another embodiment, the terminal performs some preprocessing, such as on-device feature extraction or intent classification, and transmits reduced representations to the server to lower communication load. In each configuration, the server maintains the core functionality of constructing structured context information, generating prompt sentences, invoking a generative AI model, and adjusting acoustic and textual outputs based on speaker-specific information.

The user interacts with the system by speaking into the terminal, reading or listening to responses, and optionally providing explicit feedback. The user need not understand the internal processing. The terminal presents simple graphical elements with large icons and text, and the terminal hides complexity by forwarding raw or lightly processed inputs to the server.

Through these configurations, the system provides a concrete, hardware-tied implementation of the claimed invention in which the server improves the internal operation of speech and language processing pipelines, the terminal provides real-time capture and presentation of multimodal information, and the user receives personalized, intelligible assistance. The described architecture and data flows ensure that the invention can be practiced by those skilled in the art using standard computing components and known development frameworks, while realizing the claimed technical improvements in recognition robustness, response generation stability, computational efficiency, and adaptive personalization.

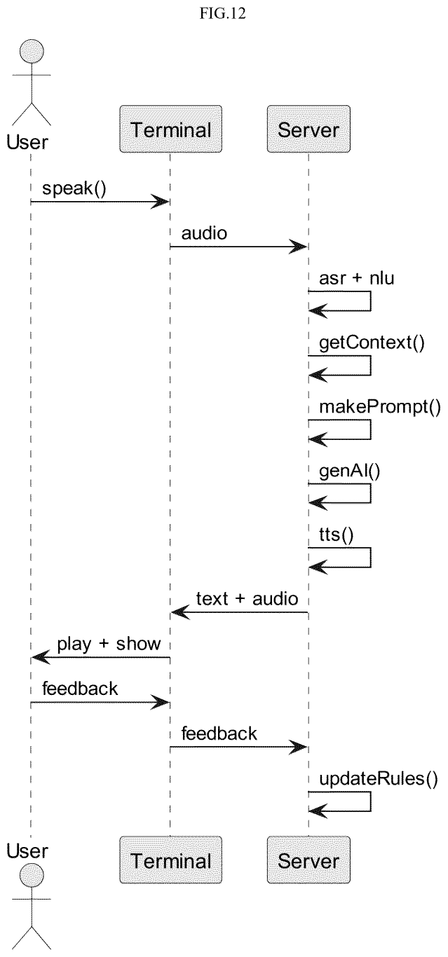

The following describes the processing flow using FIG. 12.

### Step 1:

User speaks an inquiry.

User generates an input by uttering a natural language question or request, such as “What is for lunch today?”, “When should I take my medicine?”, or “Can you tell me today's schedule?”.

This spoken utterance serves as the raw acoustic input to the system.

### Step 2:

Terminal captures and transmits acoustic information.

Terminal receives the acoustic input from the user through a microphone and converts the analog signal into digital audio samples (for example, 16-bit PCM at 16 kHz). Terminal stores the audio samples in a buffer and segments them into frames. Based on these audio frames as input, terminal performs optional local preprocessing such as noise suppression or voice-activity detection using built-in audio processing libraries, and then outputs a sequence of compressed audio packets. Terminal encapsulates the audio packets into a network request and transmits them to the server via a secure communication protocol.

### Step 3:

Server decodes audio and extracts acoustic features.

Server receives the compressed audio packets from the terminal as input. Server decodes the packets to reconstruct raw audio samples and stores the samples in a memory buffer. Based on the raw samples, server computes time-frequency representations such as short-time Fourier transforms, mel-spectrograms, and mel-frequency cepstral coefficients. Server further extracts prosodic features including pitch contours, energy trajectories, and pause durations. Server outputs a feature sequence that represents the acoustic information in a compact, numerical form suitable for machine processing.

### Step 4:

Server updates speaker-specific acoustic model information.

Server takes as input the extracted acoustic feature sequence and a speaker identifier associated with the user. Server feeds the feature sequence into a neural acoustic model that includes, for example, a convolutional front-end and a recurrent or transformer-based encoder. Server calculates predicted phonetic states and prosodic parameters and compares them with target labels or previously learned distributions. Using this comparison, server performs a weight update (for example, by gradient descent on a loss function combining cross-entropy and prosody deviation penalties) to adapt the model to the current speaker. Server aggregates statistics such as average speech tempo and typical pitch range and stores these statistics together with the updated model weights as speaker-specific acoustic model information. Server outputs both the updated acoustic model parameters and the derived statistics for later use.

### Step 5:

Server performs automatic speech recognition using the adapted model.

Server receives as input the acoustic features and the speaker-specific acoustic model information. Server applies a decoding algorithm, such as beam search over a sequence of phonetic or subword units, using the adapted acoustic parameters to compute likelihoods for each time frame. Based on these likelihoods and a language model, server calculates the most probable sequence of linguistic units that corresponds to the audio. Server outputs a text string representing a natural language inquiry sentence such as “What is today's lunch?” or “When should I take my medication?”, and may also output confidence scores.

### Step 6:

Server detects inquiry type and extracts target information.

Server takes as input the recognized text string and uses a language understanding module to classify the text into an inquiry type and to extract target information. For example, server applies a transformer-based classifier to obtain an intent label such as “ask_menu”, “ask_medication_time”, or “ask_schedule”, and performs named entity recognition to identify dates, times, item names, or symptom descriptions. Based on this analysis, server outputs an inquiry type and a set of structured entities (for example, {“meal_type”: “lunch”}, {“medication”: “blood pressure medicine”, “time”: “next dose”}).

### Step 7:

Server retrieves management and state information.

Server uses the inquiry type, target information, and speaker identifier as input keys to query a management information storage unit. Server executes database queries to obtain schedule information, intake information, nutrition information, state index information, and history information relevant to the inquiry. For example, for an “ask_menu” inquiry, server retrieves today's lunch menu and any allergy records; for an “ask_medication_time” inquiry, server retrieves a medication schedule and last intake time. Server merges the query results into a set of normalized records, and outputs these records as retrieved management and state data.

### Step 8:

Server constructs structured context information.

Server receives the retrieved management and state data as input and maps each record into a predefined schema. For example, server converts schedule entries into fields {“event_type”, “start_time”, “end_time”, “description”}, and converts recent vital measurements into fields {“metric”, “value”, “timestamp”, “reference_range”}. Server links these records with the current inquiry by attaching the speaker identifier, date, and inquiry type. Server composes a context object that lists only the fields necessary for the current inquiry, thereby reducing redundant data. Server outputs structured context information that is ready to be embedded into a prompt sentence.

### Step 9:

Server generates a prompt sentence for the generative AI model.

Server takes as input the natural language inquiry sentence, structured context information, and speaker attributes and preferences. Server applies prompt-generation rules that specify how to compose an instruction for the generative AI model, including tone, language, and safety constraints. Based on these inputs, server concatenates text segments such as an instruction header, the user's question, and formatted context. For example, server generates a prompt sentence such as:
“Using only the care data provided below (menus, medications, schedules, allergies, vitals), generate a concise and accurate answer in polite English suitable for an elderly user. Do not invent data that is not provided.
Question: “What is today's lunch?”
Menu: “Braised fish and stewed vegetables”
Allergy: “Shrimp allergy”
User preference: “Brief and gentle wording”

Server outputs this composed prompt sentence as textual input to the generative AI model.

### Step 10:

Server invokes the generative AI model and generates a natural language response sentence.

Server provides the prompt sentence as input to a generative AI model, such as a transformer-based language model with multiple attention layers and a large vocabulary. Server tokenizes the prompt sentence, computes token embeddings, and runs the model to calculate attention-weighted hidden states. Using these hidden states, server repeatedly computes probability distributions over the vocabulary and selects output tokens according to configured generation parameters (for example, temperature and top-k settings). Server concatenates selected tokens to form a response. Server outputs a natural language response sentence tailored to the speaker, such as “Today's lunch is braised fish and stewed vegetables.” or “Please take your next medication after lunch at 1:00 p.m.”, together with optional metadata such as length and confidence.

### Step 11:

Server post-processes the response and applies style and safety constraints.

Server receives the raw natural language response sentence from the generative AI model as input. Server checks the response against expression constraint information, sentence length control information, and vocabulary control information. Server may split long sentences, replace complex terms with simpler synonyms, or insert predefined phrases (such as reminders to contact staff) when required. If the response violates critical constraints (for example, suggests a medical diagnosis), server may regenerate the response with stricter prompt instructions. Server outputs a finalized natural language response sentence that conforms to the system's rules and the speaker's preferences.

### Step 12:

Server converts the natural language response sentence into acoustic response information.

Server takes as input the finalized natural language response sentence and the speaker-specific acoustic model information and listening characteristic information. Server converts the text into phoneme or character sequences and applies a text-to-speech model to generate mel-spectrograms. Server uses the speaker's tempo and prosody statistics to adjust duration and pitch contours, and uses listening characteristic information to set target speech rate and volume. Server then applies a neural vocoder to convert the mel-spectrogram into a waveform. Server outputs acoustic response information, which is a digital audio signal representing synthesized speech adapted to the speaker.

### Step 13:

Server records interaction data in a time series.

Server uses as input the inquiry sentence, the prompt sentence, the final natural language response sentence, and the structured context information, as well as timestamps and speaker identifiers. Server writes a record to a database that includes these fields along with additional metadata such as prompt template identifiers and model configuration parameters. Server stores these records in time order so that later processing can analyze patterns over multiple interactions. Server outputs updated log tables that capture the relationship between prompts, contexts, and responses.

### Step 14:

Server transmits the response to the terminal.

Server takes as input the acoustic response information and the final natural language response sentence and encapsulates them into a response message. Server compresses the audio if necessary, attaches identifiers and timestamps, and sends the response message through the network interface to the terminal. Server outputs a network packet stream that the terminal can decode into audio and text.

### Step 15:

Terminal presents audio and visual outputs to the user.

Terminal receives the response message from the server as input. Terminal decodes the acoustic response information into a playable audio stream and sends the audio samples to the audio output device at an appropriate sampling rate. Terminal simultaneously displays the natural language response sentence on the display in a large, high-contrast font. If configured, terminal shows additional control elements, such as buttons for replaying the response or adjusting volume. Terminal outputs sound waves and visual text that the user perceives as a guided, personalized answer.

### Step 16:

User provides optional feedback on response quality.

User observes or listens to the response and, if desired, interacts with the terminal to indicate a rating, such as selecting “Easy to understand” or “Hard to understand.” User's action generates evaluation information that reflects the perceived comprehensibility or suitability of the response. This evaluation information serves as input to refinement processing in later steps.

### Step 17:

Terminal sends evaluation information to the server.

Terminal receives the user's rating selection as input and constructs an evaluation message that includes a conversation identifier, the selected rating, and a timestamp. Terminal transmits this evaluation message to the server via the network interface. Terminal outputs structured evaluation data suitable for processing by the server.

### Step 18:

Server updates prompt-generation and style control parameters.

Server takes as input the evaluation information associated with specific inquiry-response pairs and aggregations of interaction logs. Server computes statistics such as average comprehensibility scores per prompt template or per response length. Based on these statistics, server modifies expression constraint information, sentence length control information, and vocabulary control information. For example, server may lower maximum sentence length or increase the use of explicit connective expressions for speakers who give low comprehensibility ratings. Server updates configuration tables or model-side control vectors that are used in future prompt sentence generation. Server outputs revised prompt-generation rules that will be applied in subsequent interactions, thereby closing the adaptation loop and improving system performance over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems that combine speech recognition, natural language processing, and speech synthesis generally treat user emotion as an external or optional signal, if at all. In many architectures, the speech recognition component simply converts audio waveforms to text, a language model generates a response based only on the recognized text, and a text-to-speech engine synthesizes audio with a fixed speaking rate, pitch, and intonation. As a result, these systems often produce responses that are technically correct in content but are delivered in a tone and style that are insensitive to the user's emotional state, such as anger, anxiety, or confusion. This mismatch can degrade user trust, satisfaction, and task success, and can even escalate complaints.

Further, even where emotion estimation modules have been proposed, such modules are frequently implemented as loosely coupled add-ons that do not deeply control how a generative AI model is prompted, or how speech style parameters are computed. For example, known systems may classify emotion from text or acoustic features but still supply the generative AI model with a generic prompt that does not explicitly encode the detected emotion or domain context, thereby under-utilizing the capabilities of large generative language models. Likewise, speech synthesis components may employ static style settings or coarse, manually selected voices, rather than dynamically computed numeric parameters tied in a structured way to emotion categories and intensities.

In addition, conventional systems often lack an integrated data loop that records, in a machine-usable manner, the full dialog context-including user utterance text, estimated emotion information, generated prompt sentences, generative AI outputs, audio style parameters, and user evaluation feedback, and then uses this dialog history to improve the underlying models. Without such a closed loop, it is difficult to systematically refine emotion classifiers, prompt generation logic, and response style policies based on real user interactions.

Thus, there is a need in the field of computer-implemented dialog processing for an improved system architecture that (i) tightly couples multimodal emotion estimation with prompt sentence generation for a generative AI model, (ii) dynamically computes fine-grained audio style parameters based on emotion information and generated responses, and (iii) persistently records structured dialog history, including user feedback, to support continuous learning. Such an architecture should improve the operation of computers themselves in executing dialog processing tasks, by enabling a processor to manage data flows and model interactions in a way that produces more appropriate and effective responses while still being implementable on general-purpose computer hardware.

The specific processing by the specific processing unit 290 of the data processing device 12 in Example 2 is realized by the following means.

The present invention provides a server comprising a processor configured to receive, from a terminal device, user input information including at least one of voice information and character information, perform a speech recognition process on the voice information to generate user utterance character information, estimate an emotion state of a user by executing an emotion classification process based on at least one of the voice information, the user utterance character information, and dialog history information to generate emotion information including emotion types and index values for respective emotion types, generate prompt character information to be input to a generative language model by performing string operations on template information based on the user utterance character information, the emotion information, and domain information, convert the prompt character information into a token sequence and input the token sequence to the generative language model to generate response character information by autoregressive inference and perform inappropriate expression detection and correction on the generated response character information, determine audio style parameters defining at least a speaking rate, a pitch, an intonation, and a volume based on the emotion information and the response character information, generate and output a synthetic voice signal based on the response character information and the audio style parameters, store, in a recording medium, dialog history information including at least the user utterance character information, the emotion information, the prompt character information, the response character information, the audio style parameters, and evaluation information from the user, and perform learning processing of at least the emotion classification process and the generative language model based on the dialog history information. This enables a computing system to more effectively control data processing related to dialog interactions by tightly integrating emotion-aware prompt generation for a generative AI model, emotion-conditioned audio style computation, and feedback-driven learning, thereby improving the technical performance of computer-implemented dialog processing in terms of responsiveness, appropriateness, and adaptability.

The term “voice information” refers to information representing a user's uttered sound acquired via an audio input device and expressed as a digital signal, including waveform data and encoded audio data suitable for computational processing.

The term “character information” refers to information representing a user's utterance or input in a symbolic text form, including character strings obtained from keyboard input, touch input, or speech recognition output.

The term “user utterance character information” refers to character information that represents the content of a user's utterance, generated by applying a speech recognition process to voice information or by accepting character information directly from a user.

The term “speech recognition process” refers to a computational process that converts voice information into character information by extracting acoustic features and applying a statistical or machine learning model to estimate a sequence of symbols corresponding to spoken content.

The term “dialog history information” refers to information representing past dialog interactions between a user and a system, including user utterance character information, emotion information, prompt character information, response character information, audio style parameters, timestamps, and user evaluation information.

The term “emotion state” refers to a psychological and affective condition of a user, represented by one or more emotion types such as anger, anxiety, joy, confusion, or neutrality, and optionally by corresponding intensity levels.

The term “emotion information” refers to structured data representing a user's emotion state in a machine-usable form, including at least one emotion type and an index value or probability value associated with each emotion type.

The term “emotion classification process” refers to a computational process that outputs emotion information by applying a classification model or algorithm to features derived from at least one of voice information, user utterance character information, and dialog history information.

The term “emotion types” refers to categories used to classify a user's emotion state, each category indicating a kind of affective condition such as anger, anxiety, joy, confusion, or neutrality.

The term “index values” refers to numeric values that quantify the degree, probability, or intensity of respective emotion types, and that are generated as part of emotion information by an emotion classification process.

The term “domain information” refers to information indicating a task field or application field related to a dialog, such as customer support, healthcare consultation, education, or financial services, used to select or control prompt generation or response generation.

The term “template information” refers to data defining a text pattern or structure for a prompt, including at least one placeholder portion into which variable elements such as user utterance character information and emotion information can be embedded.

The term “prompt character information” refers to character information supplied as input to a generative language model, constructed from template information and including at least user utterance character information, emotion information, and optionally domain information, so as to condition the content and style of a generated response.

The term “string operations” refers to computational operations performed on character information, including at least concatenation, insertion, replacement, and placeholder substitution, used to generate prompt character information from template information.

The term “generative language model” refers to a machine learning model trained on text data to generate character information or token sequences in response to an input prompt, using probabilistic next-token prediction such as autoregressive generation.

The term “token sequence” refers to an ordered sequence of atomic textual units, such as characters, subword units, or words, each unit being mapped to a numerical identifier for processing by a generative language model.

The term “autoregressive inference” refers to a process in which a model repeatedly predicts a next token in a token sequence based on previously generated tokens and an input prompt, thereby generating a response token sequence one token at a time.

The term “response character information” refers to character information generated by a generative language model in response to prompt character information and expressing a system's reply to a user's input.

The term “inappropriate expression detection” refers to a process of analyzing response character information to identify expressions that violate predetermined safety policies, legal requirements, or content guidelines, such as offensive, harmful, or disallowed expressions.

The term “correction” refers to a process of modifying response character information by removing, replacing, or regenerating portions identified by inappropriate expression detection, to produce sanitized response character information suitable for presentation to a user.

The term “audio style parameters” refers to numeric or symbolic parameters that define characteristics of synthesized speech, including at least speaking rate, pitch, intonation pattern, and volume, to control the style and prosody of generated audio output.

The term “speaking rate” refers to a parameter that controls the temporal speed of synthesized speech, such as the number of phonetic units or syllables produced per unit time or a relative rate factor with respect to a default rate.

The term “pitch” refers to a parameter that controls the fundamental frequency level of synthesized speech, influencing the perceived highness or lowness of the voice.

The term “intonation” refers to a parameter or pattern that defines temporal variation of pitch and emphasis over an utterance, affecting prosodic contours such as rising or falling tones.

The term “volume” refers to a parameter that controls the amplitude or loudness level of synthesized speech relative to a reference level.

The term “synthetic voice signal” refers to an audio signal generated by a speech synthesis process from response character information and audio style parameters, suitable for playback through an audio output device.

The term “recording medium” refers to any physical or logical data storage resource capable of storing digital information, including at least semiconductor memory, magnetic storage, optical storage, or a combination thereof.

The term “evaluation information” refers to information indicating a user's assessment of a system's response or dialog, including at least rating values, binary feedback (such as helpful or not helpful), or textual comments.

The term “learning processing” refers to a process of updating parameters of at least one model, including an emotion classification model or a generative language model, by using dialog history information as training data or evaluation data in accordance with a machine learning algorithm.

The term “processor” refers to one or more hardware computation units, such as central processing units, graphics processing units, or other programmable processing elements, configured to execute instructions implementing the processes defined in the system.

In the following embodiments, “Server” denotes an information processing apparatus including at least one processor, a main memory, a storage device, and a network interface, and “Terminal” denotes a user-operated client apparatus including at least a display, a microphone, a speaker, and an input device.

Server, Terminal, and User cooperate to implement a dialog system that estimates user emotion from multimodal input, generates an emotion-aware prompt sentence for a generative AI model, and synthesizes audio output in a style matched to the estimated emotion, while continuously improving internal models using recorded dialog history.

Server executes a server operating system such as a general-purpose server OS, and runs middleware such as a web application server, an application framework, a deep learning library (for example, a general-purpose numerical computation and deep learning framework), a transformer-model library (for example, a library for transformer-based language models), a speech-processing library (for example, a library for acoustic feature extraction and automatic speech recognition), and a relational database management system. Terminal executes a mobile operating system or a general-purpose operating system and runs an application program or a browser that communicates with Server via a network using a communication protocol. Server implements, in software executed by the processor, a set of functional modules corresponding to: (i) a speech recognition module, (ii) an emotion estimation module, (iii) a prompt generation module, (iv) a generative AI response generation module, (v) a safety and filtering module, (vi) an audio style determination module, (vii) a speech synthesis control module, (viii) a dialog history recording module, and (ix) a learning module. These modules exchange data through defined data structures stored in main memory and persistent storage. Server uses specific data structures to manage information. For example, Server uses a “UserInputRecord” structure containing fields such as an input identifier, a session identifier, a timestamp, an input mode indicator, raw or pre-processed voice information, and character information. Server uses an “EmotionInfo” structure containing a list of emotion types, a representative emotion field, and index values (for example, probability scores) for each emotion type. Server uses a “PromptRecord” structure containing the generated prompt sentence, associated template identification, and embedding parameters. Server uses a “ResponseRecord” structure containing response character information, safety flags, and post-filtering indicators. Server uses an “AudioStyleParams” structure containing numerical values for speaking rate, pitch, intonation pattern identifier, and volume level.

Server executes the speech recognition module when Terminal transmits voice information. Server receives encoded audio data via the network interface, decodes the data, and stores the resulting waveform in memory as a sequence of samples. Server uses a speech-processing library to calculate acoustic features such as short-time Fourier transform coefficients, Mel spectrograms, Mel-frequency cepstral coefficients, fundamental frequency trajectories, and energy trajectories. Server then applies a neural network-based automatic speech recognition model implemented in the deep learning library. In one embodiment, Server uses an encoder-decoder architecture including a convolutional front-end to downsample and denoise the signal, a stack of transformer encoder layers to capture long-range temporal dependencies, and a decoder with attention to map acoustic representations to symbol sequences. Server trains this network using a loss function such as connectionist temporal classification or sequence-to-sequence cross-entropy, and at inference time, Server performs beam search to decode the most likely sequence of subword tokens. Server maps these tokens back to characters to obtain user utterance character information.

Server performs emotion estimation using features from both voice information and user utterance character information. Server uses the speech-processing library to derive summary acoustic features (for example, mean and variance of pitch, energy contours, speaking rate) across the utterance. Server uses a natural language encoder, such as a transformer-based text encoder implemented in the transformer-model library, to map the utterance text into a fixed-length embedding vector. Server concatenates the acoustic feature vector and textual embedding vector into a composite feature vector. Server feeds this composite vector to an emotion classification network implemented in the deep learning library. In one embodiment, this network comprises multiple fully connected layers with non-linear activation functions and a softmax output layer producing a probability distribution across emotion types such as anger, anxiety, joy, confusion, and neutral. Server learns the parameters of this network by minimizing a cross-entropy loss over labeled training data, and may apply regularization and data augmentation techniques such as adding noise to acoustic features or synonym substitution in text to improve generalization. This architecture enables Server to exploit interactions between prosodic and lexical cues that human operators do not consistently perceive or quantify, thereby improving the precision and robustness of emotion estimation.

Server uses the resulting distribution to derive emotion information. Server sets the representative emotion to the emotion type with the maximum probability and stores the full vector of probabilities as index values. Server optionally adjusts confidence thresholds or applies calibration based on stored statistics in dialog history information. Because Server maintains emotion information as a structured numeric representation, downstream modules can use fine-grained intensity values rather than binary emotion flags, which enables more nuanced control of prompt generation and audio style parameters.

Server generates prompt character information by combining a domain-aware template with the user utterance character information and the emotion information. Server maintains, in persistent storage, a template repository containing multiple natural-language templates categorized by domain (for example, a support domain, a healthcare domain, or an education domain) and by representative emotion pattern (for example, anger-oriented, anxiety-oriented, neutral-oriented).

Each template includes placeholders for at least an emotion descriptor, intensity descriptors, and the raw user utterance. Server uses an application framework to retrieve a matching template from the repository using the current domain information and the representative emotion in the emotion information. Server then executes string operations to substitute placeholder segments with actual content.

For example, in a support domain scenario with representative emotion “anger”, Server may generate prompt character information of the following form:
“You are a customer support representative for home appliances.

According to an emotion analysis engine, the user is strongly feeling ‘anger’.

First empathize with the user's feelings and, if appropriate, apologize.

Then provide a concrete and easy-to-understand solution in English.
User utterance: ‘I bought this just a month ago, and it has already broken several times. I'm really frustrated. What is going on?’”

In another embodiment for a healthcare domain with representative emotion “anxiety”, Server may generate prompt character information of the following form:
“You are an operator at a general medical consultation desk.

According to an emotion analysis engine, the user is strongly feeling ‘anxiety’.

Use wording that helps the user feel reassured, and explain, as general information, typical criteria for seeking medical care and basic self-care methods.

Do not perform any diagnosis. Limit yourself to suggesting when to seek medical attention and pointing to appropriate consultation services.
User utterance: ‘For the last few days, my heart has been racing and I'm really worried. Should I go to the hospital?’”

Server, by explicitly encoding the estimated emotion, its intensity, and the domain-specific role and constraints into the prompt sentence, reconfigures the input state of the generative AI model in a way that cannot be readily replicated by human operators manually adjusting each response. This structured prompt generation improves the ability of the generative language model to produce responses that are both content-appropriate and style-appropriate, thereby improving response quality and reducing the need for post-hoc corrections.

Server converts the prompt character information into a token sequence using a tokenizer associated with the generative language model. The tokenizer maps subword units to integer identifiers. Server constructs a tensor from this sequence and passes it to a generative language model implemented with the transformer-model library and deep learning library. In one embodiment, Server uses a multi-layer transformer network with self-attention, feed-forward layers, and positional encodings. Server performs autoregressive inference by repeatedly computing, at each generation step, a probability distribution over the next token given the prompt and all previously generated tokens. Server uses decoding strategies such as top-k sampling, nucleus sampling, or constrained decoding to balance diversity and coherency, and stops generation when an end-of-sequence token or a maximum length is reached. This procedure allows Server to generate long-form responses with contextually consistent style and content while controlling computational complexity.

Server applies a safety and filtering module to the generated response character information. Server uses rule-based filters, regular expressions, and optionally an auxiliary classification network to identify content that violates predetermined safety rules. Server replaces or removes inappropriate segments or triggers a re-generation with stricter decoding parameters or with an augmented prompt that instructs avoidance of certain topics. By automating this filtering within the server's data path, Server ensures that generated responses remain within acceptable bounds, and this process can operate at machine speed and scale beyond what human review could achieve.

Server determines audio style parameters based on the emotion information and response character information. Server maintains a mapping table in storage that associates emotion types and intensity ranges with baseline numeric values for speaking rate, pitch offset, intonation pattern identifiers, and volume factors. For example, Server may define that for representative emotion “anger” with high intensity, the speaking rate parameter is set to 0.9 times a baseline rate, the pitch parameter is set to a partially lowered frequency, and the intonation pattern identifier selects a calm, de-escalating contour. For representative emotion “anxiety” with high intensity, Server may set the speaking rate to 0.85 times baseline, maintain or slightly raise pitch, and select an intonation profile that emphasizes reassurance. Server optionally analyzes the response character information to apply additional adjustments, such as reducing pitch variation during legal or medical disclaimers. Because Server computes audio style parameters numerically and automatically, Terminal can consistently synthesize audio that conforms to the mapped prosody, and this controlled mapping reduces variability and improves user perception compared to ad hoc manual voice design.

Terminal receives the response character information and audio style parameters from Server and uses the operating system's text-to-speech interface to synthesize audio. Terminal sets the TTS engine parameters (such as rate and pitch) using values from the audio style parameters and passes the response character information as text to be spoken. Terminal outputs the synthetic voice signal through a speaker. Through this arrangement, the system is not limited to abstract data manipulation but controls an actual hardware audio output chain, producing audible signals tailored to user emotion states.

Server records dialog history information in a relational database. Server inserts for each dialog turn a record that contains user utterance character information, emotion information (including representative emotion and index values), prompt character information, response character information, audio style parameters, and user evaluation information received from Terminal. Server associates these records with session identifiers and timestamps and maintains indexes to support efficient retrieval by various criteria. This structured logging enables Server to perform later batch analysis and model training using realistic interaction data.

Server executes a learning module to update the emotion classification model and generative language model using the stored dialog history information. In one embodiment, Server periodically retrieves batches of labeled or implicitly labeled interaction data from the database. For emotion classification, Server uses cases where user feedback indicates dissatisfaction or misclassification to create or refine labels. Server computes a loss function that includes a cross-entropy term for classification accuracy and a regularization term tied to user satisfaction scores, then performs gradient-based optimization (such as stochastic gradient descent or adaptive optimizers) to update the weights of the emotion network. For the generative language model, Server can fine-tune the model using instruction-like pairs of prompt character information and high-rated response character information, using a sequence-to-sequence loss, and can down-weight or exclude poorly rated interactions. Server may also use techniques such as curriculum learning, data weighting, or data augmentation (for example, paraphrasing user utterances) to improve robustness. These training mechanisms cause the models to adapt over time to actual usage patterns, thereby improving the technical performance of the dialog system without requiring manual rule updates.

Server, by structuring the data flow as described, multimodal emotion-aware feature computation, template-based yet dynamically parameterized prompt sentence construction, constrained generative text generation, numeric prosody mapping, and feedback-driven learning improves the functioning of the underlying computer system. For example, the emotion-based prompt generation reduces the number of additional dialog turns required to clarify user intent, shortening interaction duration and reducing network and computation load. The numerical audio style mapping allows the speech synthesis engine to reuse general-purpose voices and apply only parameter adjustments, reducing the need for multiple pre-recorded voices and saving storage capacity. The integrated logging and learning loop enables automated optimization of model parameters, leading to lower classification error rates and more accurate generation compared to static models, which constitutes an improvement in the operation of the computer as a dialog-processing machine.

Server can be implemented in various alternative embodiments. In one embodiment, Server employs separate neural networks for acoustic emotion estimation and textual emotion estimation and combines their outputs using a weighted fusion module that dynamically adjusts weights based on signal quality measures (for example, background noise level or automatic speech recognition confidence score). In another embodiment, Server uses a single multi-task transformer network that shares an encoder between speech recognition and emotion estimation tasks, thereby reducing computational load and improving latency. In yet another embodiment, Server employs different generative language models for different domains, automatically selecting the appropriate model instance based on domain information.

Terminal can be implemented as a smartphone, a tablet, a personal computer, or an embedded device with voice input and output. Terminal can perform certain pre-processing tasks such as audio normalization, compression, or local caching of past responses to reduce bandwidth usage. User can operate Terminal to initiate inquiries, view or listen to responses, and provide feedback. User's behavior, such as repeated playback or skipping responses, can be captured by Terminal and transmitted as additional evaluation information to Server, allowing the learning module to refine models based on implicit user signals.

By employing these configurations, Server, Terminal, and User collectively implement embodiments that enable a general-purpose computer system to execute an improved sequence of technical operations: capturing multimodal input, converting it into structured features, computing emotion-aware prompt sentences for a generative AI model, generating responses under controlled decoding strategies, mapping numeric emotion descriptors to prosodic parameters, driving a speech synthesis pipeline, and closing the loop with learning from recorded dialog data. These operations go beyond mere automation of human conversational tasks and provide concrete improvements in computational efficiency, accuracy, and resource utilization in the field of computer-implemented dialog processing.

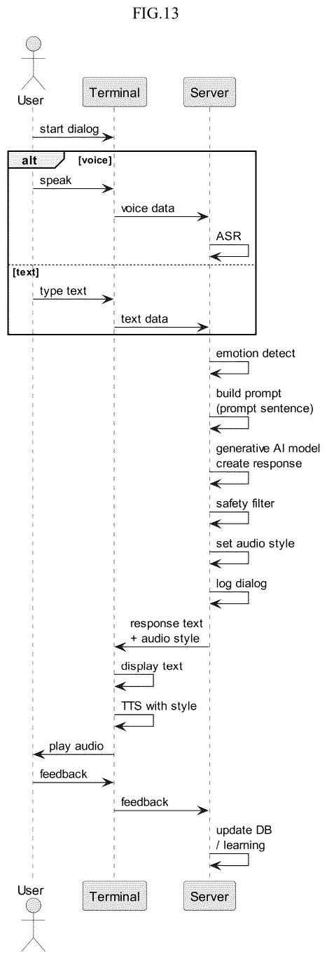

The following describes the processing flow using FIG. 13.

### Step 1:

User operates Terminal to start a dialog session.

User taps a start control on a graphical user interface of Terminal and selects either a voice-input mode or a text-input mode.

Input: User's touch or click operations on the user interface.

Output: A mode selection state in Terminal indicating which input modality (voice or text) will be used for subsequent data acquisition.

### Step 2:

Terminal acquires voice information when the voice-input mode is selected.

Terminal calls an operating-system audio input interface to start sampling a signal from a microphone at a predetermined sampling rate and bit depth, and accumulates raw audio samples in a buffer. Terminal performs pre-processing such as resampling, amplitude normalization, and noise reduction on the buffered samples to obtain pre-processed voice information.

Input: Analog speech signal from User and configuration parameters such as sampling rate and bit depth.

Output: A sequence of pre-processed digital audio samples representing the user's utterance as voice information.

### Step 3:

Terminal acquires character information when the text-input mode is selected.

Terminal presents a text input field to User, receives keystrokes or touch inputs, and constructs a Unicode string. Terminal removes redundant whitespace, standardizes line endings, and converts the internal representation to a unified character encoding to obtain formatted character information.

Input: User's character input operations and previously configured character encoding.

Output: A normalized character string representing the user's utterance as character information.

### Step 4:

Terminal packages user input and transmits it to Server.

Terminal constructs a structured message containing session identifiers, timestamps, an indicator of the input mode, and either the pre-processed voice information or the formatted character information. Terminal serializes this structure into a data format such as a text-based structured format and uses a communication library to transmit the serialized data to Server over a network channel.

Input: Pre-processed voice information or formatted character information and metadata such as session identifiers.

Output: A network request message delivered to Server containing user input information and related metadata.

### Step 5:

Server receives and parses the user input message.

Server accepts the network request through a network interface, passes it to an application framework, and parses the message body into an internal representation. Server extracts session identifiers, timestamps, the input mode indicator, and user input information, and stores these elements in a user input record structure in memory.

Input: Network request message containing structured user input information.

Output: A user input record in Server memory containing at least one of voice information and character information together with associated metadata.

### Step 6:

Server performs speech recognition when voice information is present.

Server passes the pre-processed voice information from the user input record to a speech-processing library to compute acoustic features such as short-time spectra, Mel spectrograms, and Mel-frequency cepstral coefficients. Server inputs the acoustic feature sequence into an automatic speech recognition model implemented in a deep learning framework, executes a forward computation to obtain token probabilities, and decodes the most probable token sequence using a decoding algorithm. Server converts the token sequence into a text string to obtain user utterance character information.

Input: Pre-processed voice information from the user input record and parameters of the speech recognition model.

Output: User utterance character information and associated acoustic feature vectors derived from the voice information.

### Step 7:

Server normalizes character information when text input is used.

Server reads the character information from the user input record, confirms the encoding, removes control characters, and applies normalization rules such as case folding or punctuation standardization as configured. Server designates the resulting text as user utterance character information.

Input: Character information transmitted from Terminal and normalization rules.

Output: User utterance character information produced directly from text input.

### Step 8:

Server constructs multimodal emotion-related features.

Server uses the speech-processing results and the user utterance character information to build features used for emotion estimation. Server computes summary acoustic statistics such as mean pitch, pitch variance, average energy, and estimated speaking rate over the acoustic feature vectors. Server tokenizes the user utterance character information and passes the tokens to a text encoder network to obtain a sentence-level embedding vector. Server concatenates the acoustic statistics vector and the textual embedding vector to form a composite feature vector representing both prosodic and lexical aspects of the utterance.

Input: Acoustic feature vectors (for voice input) and user utterance character information.

Output: A composite multimodal feature vector capturing acoustic and textual properties of the utterance.

### Step 9:

Server estimates a user emotion state and generates emotion information.

Server inputs the composite feature vector into an emotion classification network that outputs a probability value for each defined emotion type. Server executes a forward pass, calculates the probability distribution, and identifies the emotion type with the highest probability as a representative emotion. Server stores the full probability distribution as index values and combines the representative emotion and the index values into an emotion information structure.

Input: Composite multimodal feature vector and trained parameters of the emotion classification network.

Output: Emotion information including at least one representative emotion and index values associated with respective emotion types.

### Step 10:

Server retrieves dialog history and domain information as context.

Server queries a database using the session identifier to obtain past dialog history information including earlier user utterances, earlier emotion information, earlier responses, and any stored evaluation information. Server also obtains domain information that classifies the current dialog into an application field such as a support field or a healthcare field. Server prepares this historical and domain context as additional input for prompt generation and potential adjustment of emotion interpretation.

Input: Session identifier and stored dialog history records in the database.

Output: Contextual information comprising dialog history and domain information associated with the current session.

### Step 11:

Server selects a template for a prompt sentence.

Server searches a template repository for template information entries that match the domain information and are associated with the representative emotion specified in the emotion information. Server evaluates possible templates according to rules, such as checking emotion intensity ranges or user type, and selects a single template entry that defines a textual structure with placeholders for emotion descriptors and the user utterance.

Input: Domain information, emotion information, and template repository entries.

Output: Selected template information specifying a format for a prompt sentence to be supplied to a generative AI model.

### Step 12:

Server generates prompt character information for the generative AI model.

Server performs string operations on the selected template information. Server replaces placeholder segments with the representative emotion label, a descriptive phrase corresponding to emotion intensity, and the user utterance character information. Server concatenates template segments and inserted values to construct a coherent prompt sentence that instructs the generative language model regarding its role, user emotion, and required response style.

Input: Selected template information, emotion information, and user utterance character information.

Output: Prompt character information consisting of a fully formed prompt sentence for the generative AI model.

### Step 13:

Server converts the prompt sentence into a token sequence.

Server invokes a tokenizer associated with the generative language model, splits the prompt character information into subword units, and maps each subword to a unique numerical identifier. Server assembles these identifiers into an ordered token sequence and stores the sequence in a data structure suitable for numerical computation.

Input: Prompt character information and tokenizer vocabulary mapping.

Output: A token sequence representing the prompt sentence as numeric identifiers.

### Step 14:

Server generates response character information using the generative AI model.

Server feeds the token sequence into a generative language model implemented as a transformer-based network. Server performs autoregressive inference by repeatedly computing a probability distribution over candidate next tokens, selecting or sampling a next token according to configured decoding parameters, and appending the selected token to the sequence. Server continues this process until an end condition is met, then decodes the resulting token sequence back into a text string to obtain initial response character information.

Input: Prompt token sequence and parameters of the generative language model including decoding settings.

Output: Initial response character information generated as a textual response to the prompt sentence.

### Step 15:

Server filters and corrects the generated response text.

Server analyzes the initial response character information using rule-based filters and, optionally, a safety classification component to detect expressions that violate predetermined content policies. Server applies correction logic by removing or replacing disallowed segments or, if needed, regenerating the response under modified conditions. Server outputs sanitized response character information that conforms to safety requirements.

Input: Initial response character information and content policy rules or classifier outputs.

Output: Sanitized response character information suitable for presentation to User.

### Step 16:

Server determines audio style parameters based on emotion and response content.

Server accesses mapping information that associates combinations of emotion types and intensity values with baseline audio style parameters for speaking rate, pitch, intonation pattern identifier, and volume. Server reads the representative emotion and index values from the emotion information and selects or interpolates appropriate parameter values. Server optionally inspects the sanitized response character information for content-related cues, such as presence of sensitive topics, and adjusts parameters accordingly. Server constructs an audio style parameter structure that numerically specifies prosodic settings.

Input: Emotion information, sanitized response character information, and audio style mapping information.

Output: Audio style parameters defining numeric values for speaking rate, pitch, intonation pattern, and volume.

### Step 17:

Server records dialog history information.

Server creates a dialog history record containing the user utterance character information, the emotion information, the prompt character information, the sanitized response character information, the audio style parameters, and any existing evaluation information for the current turn. Server writes this record to a database using a structured schema, thereby updating persistent dialog history.

Input: User utterance character information, emotion information, prompt character information, sanitized response character information, audio style parameters, and evaluation information (if available).

Output: A stored dialog history record in persistent storage linked to the current session.

### Step 18:

Server transmits the response and style parameters to Terminal.

Server packages the sanitized response character information and the audio style parameters into a structured response message, attaches the relevant session identifiers and status codes, and sends the message to Terminal via a network interface.

Input: Sanitized response character information, audio style parameters, and session metadata.

Output: A network response message delivered to Terminal containing the textual response and associated audio style parameters.

### Step 19:

Terminal parses the response and prepares presentation data.

Terminal receives the network response message, deserializes it using a data parser, and extracts the response character information and audio style parameters. Terminal forwards the response character information to a display module and passes both the response character information and audio style parameters to a speech synthesis control module.

Input: Network response message containing response character information and audio style parameters.

Output: Display-ready text data and audio style parameter values prepared for speech synthesis.

### Step 20:

Terminal displays the response text to User.

Terminal renders the response character information on a display using a text widget. Terminal may apply formatting rules such as line wrapping or segmentation into sections and may provide interface controls for expanding or collapsing long responses.

Input: Display-ready response character information.

Output: A visual presentation of the system's response on the Terminal screen.

### Step 21:

Terminal synthesizes speech according to the audio style parameters.

Terminal initializes a text-to-speech engine provided by the operating system, sets its parameters for speaking rate, pitch, and volume based on the audio style parameters, and selects a voice profile appropriate for the language. Terminal submits the response character information to the engine and requests synthesis. The text-to-speech engine converts the text into a synthetic voice signal according to the specified parameters, and Terminal outputs the signal through a speaker.

Input: Response character information and audio style parameters.

Output: A synthetic voice signal played back to User with prosody matched to the determined audio style.

### Step 22:

User perceives the response and optionally provides evaluation information.

User views the displayed response text, listens to the synthetic voice, and assesses the helpfulness and tone of the response. User may interact with feedback controls presented by Terminal, such as selecting a rating or indicating whether the response was useful.

Input: Displayed response text, synthetic voice signal, and feedback controls presented by Terminal.

Output: Evaluation information entered by User representing subjective assessment of the dialog turn.

### Step 23:

Terminal acquires evaluation information and sends it to Server.

Terminal collects the evaluation information from User input, attaches session identifiers and timestamps, and packages it into a structured feedback message. Terminal transmits this feedback message to Server over the network.

Input: Evaluation information entered by User and session metadata.

Output: A feedback message sent to Server containing evaluation information linked to the dialog session.

### Step 24:

Server stores evaluation information and prepares data for learning.

Server receives the feedback message, parses its content, and associates the received evaluation information with the corresponding dialog history record in the database. Server updates the record to include the evaluation fields and marks the data as available for training or validation.

Input: Feedback message containing evaluation information and references to dialog history records.

Output: Updated dialog history records including evaluation information to be used as training data for subsequent learning processing.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog systems that combine speech recognition, natural language processing, and speech synthesis generally treat recognition, language understanding, and output rendering as loosely coupled and emotion-agnostic components. In many implementations, speech recognition modules merely output text, language models generate responses solely based on that text, and text-to-speech engines synthesize audio with fixed prosodic parameters. As a result, such systems fail to leverage available multimodal signal information, contextual records, and longitudinal user data to control how a generative AI model is prompted and how its outputs are delivered. This leads to several technical problems in computer processing.

First, existing architectures do not systematically integrate acoustic feature information and character information into a unified emotion state information that is persistently stored and reused. Typical systems either ignore prosodic and paralinguistic cues or use them only transiently, without maintaining a structured emotion history in association with user identifiers and other context. This lack of structured, time-series emotion state information prevents downstream modules from performing informed control of generative AI model behavior and user interface rendering, and thereby limits the system's ability to dynamically adapt its computational processing to the user's condition.

Second, many systems that invoke a generative AI model rely on static or minimally parameterized prompts. They do not dynamically construct a prompt sentence based on a combination of emotion state information and heterogeneous context information, such as attribute information, health state information, schedule information, intake information, medication information, and dialogue history information stored in an information storage device. Consequently, the generative AI model is under-conditioned, and its internal computation cannot be steered in a structured way according to the user's real-time state and stored records. This results in inefficient utilization of model capacity, suboptimal response selection, and increased need for external post-processing logic.

Third, output generation pipelines in conventional systems typically synthesize audio with fixed or coarse-grained parameters and display text in static user interfaces. They do not algorithmically couple emotion state information and attribute information to the control of speech rate, sound volume, pitch, and prosody in the speech synthesis process, nor do they generate explicit user interface control information for adaptive control of color schemes, font sizes, display messages, and arrangement of operation areas on a terminal display. This decoupling leads to rigid output behavior, and forces client applications or human operators to perform ad hoc adjustments, thereby increasing processing overhead and latency at the terminal and reducing overall system robustness.

Fourth, existing dialog systems rarely employ the stored emotion state information and health state information to perform automated aggregation and threshold-based evaluation of negative emotion occurrence states for the purpose of generating caregiver notifications. Without such integrated aggregation and decision logic in the server-side computation, computer resources are either wasted on continuous manual monitoring or are unable to proactively detect early signs of psychological deterioration. This limits the system's capability to function as an intelligent monitoring infrastructure that automatically escalates certain events to caregiver terminals. Accordingly, there is a need for a computer-implemented system and server-side processing architecture that (i) acquires and fuses acoustic feature information and character information to estimate and store emotion state information as structured history, (ii) dynamically constructs a prompt sentence for a generative AI model based on the emotion state information and rich stored context, (iii) controls speech synthesis parameters and user interface presentation on terminals as explicit functions of the emotion state information and attribute information, and (iv) aggregates negative emotion occurrence states to generate notification information for caregiver terminals. Such a system should improve the technical functioning of dialog processing infrastructure by reducing manual configuration, increasing processing efficiency and consistency, and enabling more precise control over generative AI model behavior and multimodal output rendering.

The specific processing by the specific processing unit 290 of the data processing device 12 in Application Example 2 is realized by the following means.

The present invention provides a server comprising a processor configured to receive audio information acquired by a terminal, extract acoustic feature information from the audio information, perform speech recognition to obtain character information from the audio information, estimate emotion state information on the basis of the acoustic feature information and the character information, and record the emotion state information as history information in association with a user identifier and time information; an information storage device configured to store, in association with the user identifier, at least a part of attribute information, health state information, schedule information, intake information, medication information, dialogue history information, and the emotion state information, the processor being further configured to manage the stored information in association with the emotion state information, dynamically construct a prompt sentence to be input to a generative AI model on the basis of the emotion state information and the information stored in the information storage device, and input the prompt sentence and at least a portion of the stored information to the generative AI model to cause the generative AI model to generate a response sentence in a natural language format; a speech synthesis unit controlled by the processor and configured to convert the response sentence into audio information while controlling speech rate, sound volume, pitch, and prosody of speech synthesis on the basis of the response sentence, the emotion state information, and the attribute information; and a user interface control unit controlled by the processor and configured to generate user interface control information, for controlling at least a color scheme, a character size, a display message, and an arrangement of an operation area of a display unit of the terminal, on the basis of the response sentence and the emotion state information, transmit the user interface control information and the audio information to the terminal, aggregate occurrence states of negative emotions on the basis of the emotion state information and the health state information, and, when an aggregation result satisfies a predetermined condition, transmit notification information to a caregiver terminal. This enables the server to implement an integrated, emotion-aware control loop in which multimodal inputs are fused into structured emotion state information, generative AI model computation is conditioned by dynamically constructed prompt sentences that reflect real-time and stored context, speech synthesis and user interface rendering are automatically adapted based on computed emotion state information and attribute information, and negative emotion trends are algorithmically detected and notified to caregiver terminals, thereby improving the technical operation, efficiency, and adaptability of computer-implemented dialog processing systems.

The term “audio information” refers to data representing sound captured by an input device, including digitized representations such as pulse-code-modulated signals or compressed audio data that encode a user's speech.

The term “terminal” refers to an information processing device that includes at least an audio input unit, an audio output unit, and a display unit, and that communicates with a server to transmit audio information and receive audio information and user interface control information.

The term “acoustic feature information” refers to numerical parameters computed from audio information, including at least pitch, energy, speaking rate, prosodic variation, silence durations, and spectral characteristics, which are used as input to a speech emotion classification model.

The term “speech recognition” refers to a computational process that converts audio information representing spoken utterances into character information expressed as a sequence of textual symbols.

The term “character information” refers to text data obtained from speech recognition that represents the linguistic content of a user's utterance.

The term “emotion state information” refers to information indicative of a psychological state of a user, including at least an emotion label representing a category such as joy, anger, anxiety, sadness, or neutrality, and optionally an emotion intensity value.

The term “history information” refers to time-series data in which emotion state information is stored in association with at least a user identifier and time information so that past emotion states can be retrieved and analyzed.

The term “attribute information” refers to user-related profile data, including at least age, biological sex, sensory characteristics, linguistic characteristics, and preference characteristics relevant to dialogue control and output adaptation.

The term “health state information” refers to medical-related data about a user, including at least diagnostic information, symptom information, and physiological measurement information, which is used for context-aware processing and monitoring.

The term “schedule information” refers to planned activity data concerning a user, including at least times and contents of daily activities, such as meals, rehabilitation sessions, medical examinations, and other scheduled events.

The term “intake information” refers to data relating to ingestion activities of a user, including at least meal menu data, serving times, and nutritional characteristics associated with food or drink.

The term “medication information” refers to data related to pharmaceutical intake of a user, including at least drug names, dosage amounts, administration times, and adherence status.

The term “dialogue history information” refers to records of past interactions between a user and a system, including at least user utterances, system responses, timestamps, and associated metadata used as conversational context.

The term “information storage device” refers to a storage apparatus, including at least one of a volatile memory and a nonvolatile memory, configured to store attribute information, health state information, schedule information, intake information, medication information, dialogue history information, and emotion state information.

The term “generative AI model” refers to a machine learning model, including at least a large language model, that is configured to generate natural-language text in response to input data such as a prompt sentence and context information.

The term “prompt sentence” refers to an input text provided to a generative AI model, including at least instructions, conditions, context information, and user utterance content, which guides the model's response generation behavior.

The term “response sentence” refers to a natural-language text output generated by a generative AI model in response to a prompt sentence, which is intended to be presented to a user.

The term “speech synthesis” refers to a computational process that converts text data, such as a response sentence, into audio information representing synthetic speech.

The term “speech rate” refers to a temporal parameter of synthesized speech, including at least the speed at which phonetic units or words are articulated in the synthesized audio information.

The term “sound volume” refers to an amplitude-related parameter of synthesized speech that determines the loudness level of the audio information output to a user.

The term “pitch” refers to a frequency-related parameter of synthesized speech that determines the perceived fundamental frequency of the audio information.

The term “prosody” refers to suprasegmental characteristics of speech, including at least intonation, rhythm, and stress patterns applied to synthesized audio information.

The term “user interface control information” refers to control data generated by a server for a terminal, including at least parameters for color schemes, character sizes, display messages, and layout of operation areas on a display unit.

The term “display unit” refers to a visual output device of a terminal configured to present textual information, graphical elements, and user interface components to a user.

The term “operation area” refers to a designated region on a display unit that receives user input, including at least buttons, touch-sensitive regions, or other interactive components.

The term “negative emotions” refers to emotion categories associated with adverse psychological states, including at least anxiety, anger, and sadness, represented within emotion state information.

The term “occurrence states of negative emotions” refers to data indicating the presence, frequency, or duration of negative emotions within emotion state information over a specified period.

The term “aggregation result” refers to an outcome of a computational process that combines multiple instances of emotion state information, including at least counted frequencies, statistical measures, or threshold evaluations of negative emotions.

The term “caregiver terminal” refers to an information processing device operated by a caregiver, which is configured to receive notification information, display alerts, and optionally present related user state data.

The term “notification information” refers to alert data transmitted to a caregiver terminal, including at least user identification data, summary information about emotion state information or health state information, and an indication that a predetermined condition has been satisfied.

The term “processor” refers to a hardware computation unit, including at least one central processing unit or processing circuitry, configured to execute instructions to perform operations defined in the system.

Server, terminal, and user cooperate to implement embodiments of the invention. In the following description, server denotes a computing apparatus including at least one processor, a main memory, and a nonvolatile storage device, operating under a general-purpose operating system such as a server-grade operating system. Terminal denotes an information processing device such as a smartphone, tablet, or dedicated embedded terminal, including a microphone, a speaker, and a display unit, and operating under a mobile or embedded operating system. User denotes a human operator, typically an elderly care receiver, who interacts with terminal primarily through spoken utterances and simple touch interactions.

Server executes an application program comprising multiple software modules, including at least a web service module, an audio processing module, a speech recognition module, a feature extraction module, a multimodal emotion estimation module, a context management module, a prompt construction module, a generative AI interface module, a speech synthesis module, and a user interface control module. Server also accesses an information storage device comprising a combination of a relational database management system and a nonrelational database system.

Terminal executes an application that uses device-level audio input and output APIs, graphics frameworks, and network libraries to capture user speech, to transmit and receive data to and from server, and to present audio and visual output based on control information generated by server.

User speaks toward terminal, and terminal acquires the analog audio signal through the microphone hardware. Terminal, by using an audio input API provided by the operating system, converts the analog signal into digital audio information expressed, for example, as 16-bit linear pulse-code-modulated samples at a sampling frequency of 16 kHz. Terminal stores the audio samples in a ring buffer in main memory, associates the buffer with metadata such as a user identifier, a terminal timestamp, and a conversation identifier, and prepares the data for transmission.

Terminal compresses the digital audio using an audio codec library, such as an implementation of a low-bit-rate codec, so that the network payload size is reduced while preserving speech quality sufficient for downstream processing. Terminal uses a network communication library to build a request message in a structured format such as a binary container or a structured text representation, embeds the compressed audio information and metadata, and sends the message to a preconfigured endpoint of server over an encrypted transport protocol.

Server receives the request using the web service module, which may be implemented on top of a web framework. Server extracts the compressed audio and metadata from the request body and invokes a decoding function of an audio decode library to restore the compressed audio into a standardized PCM representation. Server stores the PCM audio, together with user identifiers and timestamps, in an internal data structure, which can be implemented as a record in a processing queue held in main memory.

Server performs speech recognition by passing the PCM audio to a speech recognition module. The speech recognition module can be implemented using a neural-network-based automatic speech recognition model. For example, server can use a model comprising a convolutional front-end for low-level feature extraction, followed by recurrent or transformer layers trained to map acoustic features to subword units. Server executes this model on the audio frames by performing matrix multiplications, non-linear activation functions, and beam-search decoding with a language model, and thereby generates character information that represents the recognized text of the user's utterance.

Server, in parallel, executes a feature extraction module that computes acoustic feature information from the same PCM audio. Server calculates, for each short-time frame, spectral coefficients such as Mel-frequency cepstral coefficients, short-time energy, and pitch tracks, and derives higher-level aggregates such as speaking rate and prosodic contours. Server arranges these values into a fixed-dimensional feature vector, for example by concatenating statistics such as means, variances, and extreme values over the utterance duration. This acoustic feature information serves as input to the multimodal emotion estimation module.

Server estimates emotion state information by combining audio and textual cues. In one embodiment, server employs a speech emotion classification model that takes the acoustic feature vector as input. This model may be implemented as a deep neural network including, for example, an input layer matching the dimension of the feature vector, a plurality of fully connected layers or convolutional layers with rectified linear unit activations, and an output layer that produces, via a softmax function, probability values over a set of emotion classes such as joy, anger, anxiety, sadness, and neutrality.

Server, in addition, passes the recognized character information to a text emotion classification model. Server may implement this model as a transformer-based architecture pre-trained on general text and fine-tuned on emotion-labeled sentences. Server tokenizes the character information into subword units, maps them to dense embeddings, applies multiple layers of self-attention and feed-forward transformations, and produces class probabilities corresponding to the same set of emotion classes.

Server integrates the outputs of these two models by a deterministic fusion algorithm. For example, server multiplies or adds the class-wise probability values using predetermined weights, such as a larger weight for acoustic cues when prosody is reliable and a larger weight for text cues when semantic content is more indicative. Server then normalizes the fused values to derive integrated probability values for each emotion class. Server selects the class having the maximum integrated probability as an emotion label and treats the corresponding value as an emotion intensity value. Server groups the emotion label and intensity into emotion state information and records this in history information stored in a nonrelational database, associating each record with a user identifier and a time stamp.

Server manages heterogeneous context data in an information storage device. In an embodiment, server stores attribute information, health state information, schedule information, intake information, and medication information in a relational database, using predefined schemas and indexes keyed by user identifiers and date ranges. Server stores dialogue history information and emotion history information in a document database, enabling flexible retrieval of past conversation turns and emotion trajectories. By maintaining this structured data, server can respond to queries without recomputing context from raw logs, thereby improving processing speed and reducing computational overhead.

Server constructs a prompt sentence for a generative AI model based on the emotion state information and the stored context. Server selects a template from a template repository according to the current emotion label. In a neutral state, server uses a base template, while in an anxiety or anger state, server uses a template that contains additional instructions for reassuring or de-escalating language. Server retrieves relevant context, such as today's meal menu, allergies, and medication schedule, from the storage device by issuing database queries. Server then fills designated slots in the template with this information and with the recognized user question, using controlled string concatenation operations to ensure consistent format.

For example, server can generate a prompt sentence in a neutral case as follows:
“You are a voice-based support system for a care facility.
Please answer the care receiver's question according to the following conditions.
   Answer in English.
   Do not state anything that contradicts the information registered in the facility's database.
   Use simple, gentle wording that is easy for elderly people to understand.
[Registered information]
   Today's lunch menu: braised fish and stewed vegetables
   Care receiver's allergy: shrimp allergy
   Medication schedule: blood-pressure medicine at 12:00 and 18:00
[Care receiver's question] “What
is today's lunch?”
Based on the above, respond in one or two sentences that are easy for the care receiver to understand.”

In an anxiety state, server can generate a prompt sentence including explicit control of response style:
“You are a voice-based support system for a care facility.
The questioner is likely feeling anxious at present.
Please answer the care receiver's question according to the following conditions.
   Answer in English.
   Do not state anything that contradicts the information registered in the facility's database.
   Use simple, gentle wording that is easy for elderly people to understand.
   To reassure the questioner, add one reassuring sentence at the end of your answer.
   Avoid expressions that unnecessarily heighten anxiety.
[Registered information]
   Today's lunch menu: braised fish and stewed vegetables
   Care receiver's allergy: shrimp allergy
   Medication schedule: blood-pressure medicine at 12:00 and 18:00
   Medication adherence today: all scheduled doses have been taken
[Care receiver's question]
“I'm worried that I may not be taking my medication correctly.”
Based on the above, respond in two or three sentences in a way that reassures the care receiver.” Server passes the constructed prompt sentence, together with a subset of the context data as additional input fields, to the generative AI interface module. This module formats the prompt sentence in the protocol required by the generative AI model and sends it over a network interface. The generative AI model, which may be implemented as a large-scale transformer network with billions of parameters, processes the prompt sentence by performing self-attention operations and next-token prediction steps, and returns a response sentence as a sequence of tokens. Server receives the response sentence and logs it, together with the prompt sentence and the associated metadata, in the dialogue history information.

Server converts the response sentence into audio information using the speech synthesis module. In one embodiment, server uses a neural text-to-speech engine with an encoder-decoder architecture. Server first converts the response sentence into a sequence of phoneme or character embeddings, then applies a prosody prediction network that is parameterized by emotion state information and attribute information. For example, server adjusts target durations and pitch contours according to the emotion label: a slower rate and softer, slightly higher pitch in an anxiety state, or a more moderate tone in an anger state. Server then synthesizes a waveform through a neural vocoder, which is a model trained to map spectrograms to time-domain signals.

By encoding these parameter adjustments directly into the synthesis pipeline, server changes the low-level waveform generation process, rather than post-processing a fixed waveform, thereby reducing artifacts and improving perceived naturalness.

Server, in addition, generates user interface control information for terminal. Based on the emotion state information and other context, server specifies parameters such as background color codes, font sizes, and layout identifiers for operation areas such as “Listen again” or “Contact caregiver” buttons. Server encodes these parameters in a structured control message and sends this message, together with the synthesized audio information and the response sentence, to terminal.

Terminal receives the audio information and the user interface control information. Terminal decodes the audio using system audio APIs and sends the decoded waveform to the speaker hardware, allowing user to hear the synthesized voice. Terminal configures the display unit according to the user interface control information, for example by setting a calm color theme in an anxiety state, enlarging fonts, and placing operation areas where they are easily accessible. Terminal thereby performs device-level control of both audio and display output based on instructions derived from server's computations.

User listens to the synthesized explanation and may touch operation areas on the display. When user operates such an area, terminal generates an event and, if necessary, sends another request message to server. For example, when user requests caregiver contact, terminal sends notification data including user identifiers and current emotion state information. Server receives this data and performs aggregation of occurrence states of negative emotions from the emotion history. Server counts or otherwise measures the frequency and intensity of emotion states labeled as anxiety, sadness, or anger over a configurable time window. When the aggregation result exceeds a threshold, server generates notification information and transmits it to a caregiver terminal, which can be implemented as a workstation, a smartphone, or another terminal. This architecture ensures that caregiver notification is driven by objective, algorithmically determined thresholds applied to time-series emotion state information, rather than by ad hoc manual inspection.

The described implementations improve computer technology in several respects. Server, by storing emotion state information in a structured way and by fusing acoustic and textual probabilities through a fixed algorithm, reduces noise sensitivity compared with systems that rely solely on text or a single modality. This fusion reduces error rates in emotion estimation and leads to more consistent prompt selection. Server, by dynamically constructing prompt sentences that include explicit constraints and rich context, reduces the need for additional filtering of responses and leads to fewer calls to the generative AI model, because the model is more likely to produce an acceptable response on the first attempt. This improves processing efficiency and lowers overall computation and communication load.

Server also separates low-bandwidth control signals (user interface control information and emotion state information) from high-bandwidth media data (audio waveforms). By transmitting compact control parameters and using them to drive rendering on terminal, server reduces the amount of recomputation and re-transmission necessary when user requests simple changes such as replay or visual adjustments. Terminal can reuse already received audio data and only re-apply local control settings. This design improves communication efficiency and reduces latency. From a training and model-level perspective, server configures the emotion classification and generative AI control in a non-conventional way. The emotion classification models are trained using multi-task or multi-modal learning, where server minimizes a cost function that includes cross-entropy loss terms for both acoustic and textual emotion predictions. During training, server performs data augmentation such as time-stretching and noise addition for audio, and synonym replacement or paraphrase generation for text, to increase robustness. Server updates the model weights through gradient-based optimization, for example stochastic gradient descent with momentum or adaptive methods, and validates the models on separate data to ensure that integrated probabilities correlate with observable emotional cues.

Server's prompt construction logic encodes explicit policies as part of the data processing pipeline. For instance, server defines deterministic rules such as “if emotion label equals anxiety and intensity exceeds a threshold, then include reassurance instruction and avoid technical terminology,” which are reflected in the structure of the prompt sentence. These rules are not a simple transcription of human procedures; instead, they exploit the generative AI model's ability to follow detailed instructions and the system's structured context, enabling granularity and consistency that are difficult to achieve manually.

In alternative embodiments, server may vary the architectures of the models and the storage layouts of the databases. For example, server may use a fully transformer-based speech recognizer, or may implement the multimodal emotion fusion with a small neural network taking as input the separate acoustic and text logits instead of a linear fusion. Server may also compress stored emotion history and dialogue history using columnar formats or time-series databases to accelerate aggregation queries for notification generation. Terminal may implement additional hardware-level optimizations, such as hardware acceleration for audio decoding or text rendering, and may cache portions of user interface control information for common states. User, in all embodiments, interacts with a system whose internal computations are orchestrated such that each component-feature extraction, emotion fusion, prompt construction, generative AI response generation, speech synthesis, and interface control-performs a concrete, technically specified data transformation. The described combinations of data structures, machine-learning architectures, and deterministic rule-based processing produce an overall effect that extends beyond mere automation of human decision-making, by improving the accuracy and efficiency of emotional state estimation, by optimizing the conditioning of a generative AI model, and by enabling adaptive, low-latency control of audio and display hardware in terminal.

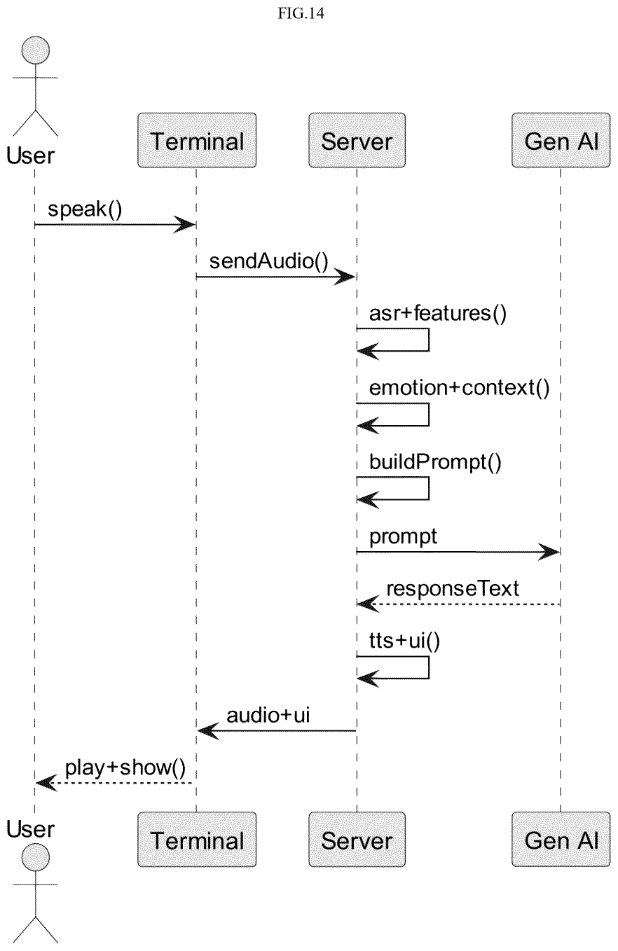

The following describes the processing flow using FIG. 14.

### Step 1:

User provides a spoken inquiry as input.

User speaks toward terminal in natural language, for example uttering “What is today's lunch?” or “I am worried whether I am taking my medicine properly.” The input is an analog voice signal produced by user's speech. The output of this step is an acoustic waveform arriving at the microphone of terminal, containing the linguistic content and prosodic characteristics of the utterance.

### Step 2:

Terminal acquires and digitizes the user's speech.

Terminal uses a microphone and an audio input API of the operating system to sample the analog waveform from Step 1 and convert it into digital audio information, for example 16-bit linear PCM samples at 16 kHz, mono. The input is the analog voice signal; terminal performs analog-to-digital conversion and buffering, and the output is a time-ordered PCM sample buffer stored in main memory. Terminal also generates metadata, including at least a user identifier, a device timestamp, and a conversation identifier, and associates this metadata with the PCM buffer.

### Step 3:

Terminal compresses audio and prepares a transmission packet.

Terminal takes as input the PCM buffer and associated metadata. Terminal invokes an audio codec library, for example an implementation of a low-bit-rate speech codec, and performs an encoding operation that transforms the PCM samples into compressed audio data, thereby reducing data size while preserving intelligibility. Terminal then constructs a network request object using a communication library, embedding the compressed audio bytes and the metadata into a structured body. The output of this step is a network packet ready to be sent to server, containing compressed audio and metadata.

### Step 4:

Terminal transmits the audio packet to server.

Terminal uses a network stack, for example an HTTPS client, to send the packet from Step 3 to a predefined API endpoint of server over an encrypted channel. The input is the request object; terminal performs protocol framing, encryption, and transport layer handling, and the output is a data stream that reaches server, ensuring the compressed audio and metadata are delivered securely.

### Step 5:

Server receives and decodes the audio packet.

Server, via a web framework, receives the HTTPS request and extracts the request body as input. Server parses the body to separate the compressed audio data and the metadata. Server then calls an audio decoding function, such as a codec decoder library, to transform the compressed audio back into a standardized PCM representation. The data processing includes bitstream parsing and inverse transform operations. The output is a PCM audio buffer along with structured metadata (user identifier, timestamp, conversation identifier) stored in an internal processing object.

### Step 6:

Server performs speech recognition to obtain text.

Server takes the PCM audio buffer from Step 5 as input to a speech recognition module. Server segments the audio into frames and passes them through an acoustic model, for example a neural network that performs matrix multiplications and non-linear activation functions to estimate subword or phoneme probabilities for each frame. Server then applies a decoding algorithm, such as beam search with a language model, to select the most probable symbol sequence. The data processing transforms acoustic features into discrete text symbols. The output is character information representing the recognized utterance, along with optional confidence scores.

### Step 7:

Server extracts acoustic feature information for emotion analysis.

Server uses the same PCM audio from Step 5 as input to a feature extraction module. Server applies digital signal processing operations such as windowing, Fourier transforms, and filter bank analysis to compute frame-level features like spectral coefficients, energy, and fundamental frequency. Server then aggregates these features over time to derive higher-level measures, including pitch contours, speaking rate, prosodic patterns, and silence durations. The data processing consists of numerical computations that map raw PCM samples to a fixed-dimensional acoustic feature vector. The output is acoustic feature information associated with the utterance.

### Step 8:

Server estimates emotion state information from audio and text.

Server inputs the acoustic feature vector from Step 7 into a speech emotion classification model, and the character information from Step 6 into a text emotion classification model. Server performs forward passes through both models, computing weighted sums, activation functions, and softmax outputs to obtain separate probability distributions over emotion classes for audio and text. Server then applies a fusion algorithm, for example a weighted average of class-wise probabilities, to integrate the two distributions. The data processing computes integrated probability values for each emotion category. The output is emotion state information consisting of an emotion label (for example “neutral” or “anxiety”) and an emotion intensity value derived from the integrated probabilities.

### Step 9:

Server records emotion history and retrieves contextual information.

Server takes emotion state information and metadata as input, and writes a new record into an emotion history data structure stored in a nonrelational database, thereby appending the current emotion label, intensity, user identifier, and timestamp. In parallel, server issues queries to an information storage device, using the user identifier and date as keys, to retrieve attribute information, health state information, schedule information, intake information, medication information, and dialogue history information. The data processing includes database lookups, joins, and document retrieval operations. The output is a consolidated context object containing current emotion state information and relevant stored context for the user.

### Step 10:

Server constructs a prompt sentence for a generative AI model.

Server takes as input the character information from Step 6, the emotion state information from Step 8, and the context object from Step 9. Server first selects a template according to the emotion label, for example a neutral template or an anxiety template. Server then fills the template by inserting schedule information, intake information, and medication information into a registered-information section, and by inserting the recognized user question into a question section. If the emotion state is negative, server further appends conditions instructing reassurance and suppression of anxiety-increasing expressions. The data processing involves conditional branching and string concatenation to generate a structured text. The output is a prompt sentence that encodes instructions, context, and user content for the generative AI model.

### Step 11:

Server obtains a response sentence from the generative AI model.

Server sends the prompt sentence from Step 10, along with any required conversation context, as input to a generative AI model via a model interface. Server's generative AI interface module formats the prompt into the request format expected by the model and transmits it. The generative AI model internally computes attention weights and next-token probabilities to generate a natural language output, and returns a response sentence. Server receives the response text as output and stores it in dialogue history together with the associated prompt sentence and identifiers.

### Step 12:

Server performs emotion-adaptive speech synthesis.

Server takes the response sentence from Step 11, the emotion state information from Step 8, and attribute information from the context object in Step 9 as input to a speech synthesis module. Server determines synthesis parameters, including speech rate, sound volume, pitch, and prosody profiles, based on rules tied to the emotion label and user attributes. For example, server selects a slower rate and softer tone when the emotion label indicates anxiety. Server then passes the text and parameter set to a text-to-speech engine, which performs linguistic analysis, prosody generation, and waveform synthesis. The data processing transforms text and numeric parameters into an audio waveform. The output is synthesized audio information representing the response sentence with emotion-adapted prosody.

### Step 13:

Server generates user interface control information.

Server uses the response sentence and emotion state information as input to a user interface control module. Server applies predefined mapping rules to derive visual parameters such as background color codes, font sizes, highlight messages, and button layout patterns appropriate for the detected emotion; for instance, server may select a calming color palette for anxiety. The data processing converts high-level emotion labels into concrete UI parameter values. The output is user interface control information specifying color scheme, character size, display message text, and arrangement of operation areas for terminal.

### Step 14:

Server sends audio and UI control information to terminal.

Server combines the synthesized audio information from Step 12, the response sentence text, and the user interface control information from Step 13 into a response payload. Server then uses its web service module to transmit this payload to terminal over a network connection. The input is the set of generated media and control data; server serializes and encapsulates this data into a message. The output is a network response delivered to terminal, containing all information necessary for audio playback and UI rendering.

### Step 15:

Terminal renders audio output and visual interface.

Terminal receives the response payload from Step 14 as input via its network communication library. Terminal parses the payload to extract the audio bytes, response text, and UI control parameters. Terminal uses an audio output API to decode and stream the audio bytes to the speaker hardware, thereby playing the synthesized response. Terminal also configures the display unit in accordance with the UI control parameters, setting background colors, font sizes, and layout of operation areas, and draws the response text and any additional messages. The output is a combined audio-visual presentation of the response to user, tailored to the detected emotion state.

### Step 16:

User interacts with the adaptive interface and may trigger caregiver notification.

User, after hearing and viewing the response from Step 15, may touch operation areas such as a “Listen again” button or a “Contact caregiver” button that appear on the display. The input to this step is the presented user interface; user's action produces a touch event detected by terminal. The output is either a local action, such as replaying the received audio, or a new message sent from terminal to server containing a request type and current identifiers. In the case of a caregiver contact, server subsequently aggregates negative emotion occurrences from history and, if a threshold is exceeded, transmits notification information to a caregiver terminal, thereby completing a loop where emotion-aware computations drive technical control of device behavior and network signaling.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

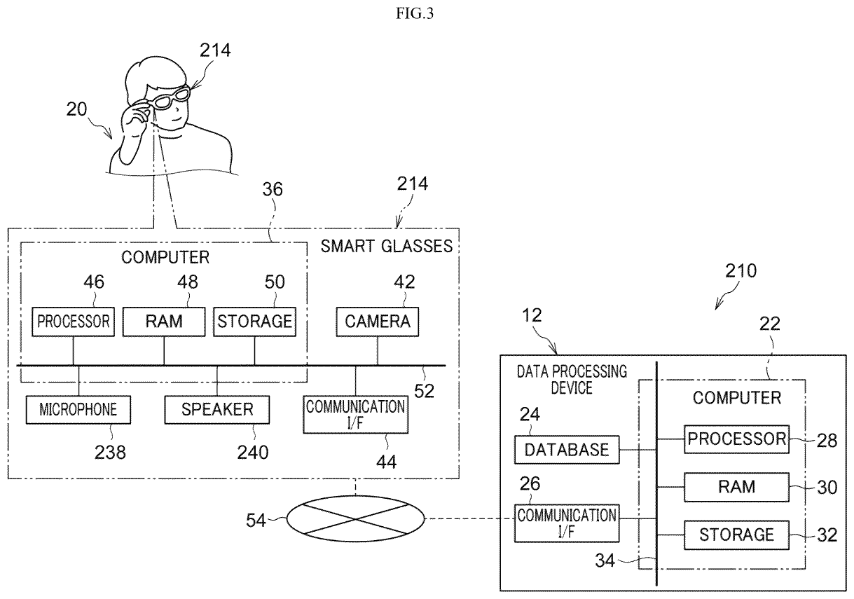

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

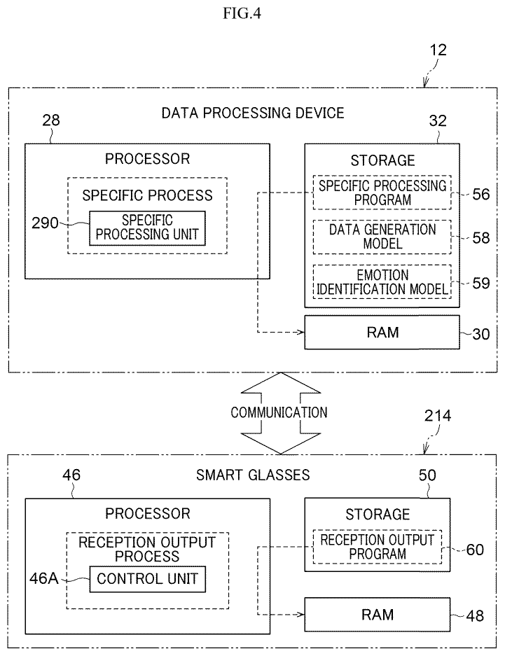

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

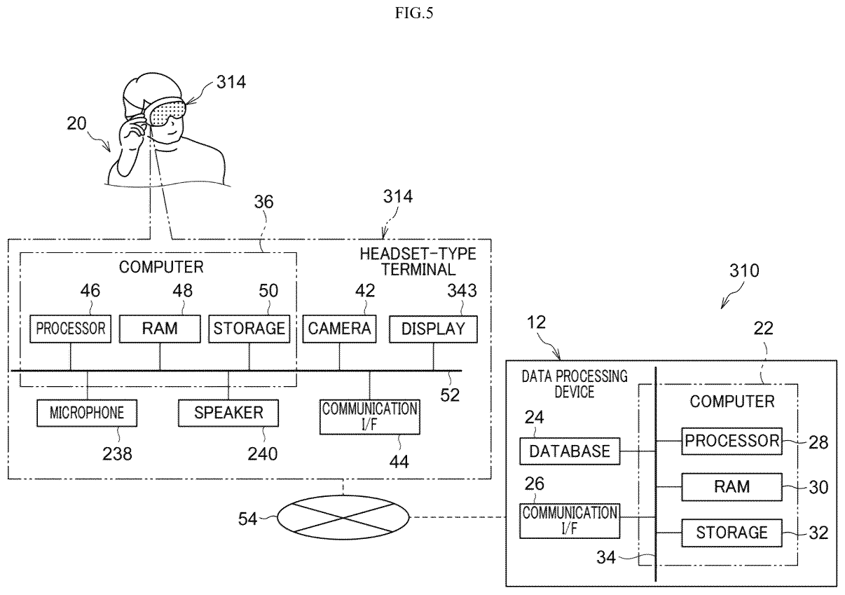

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

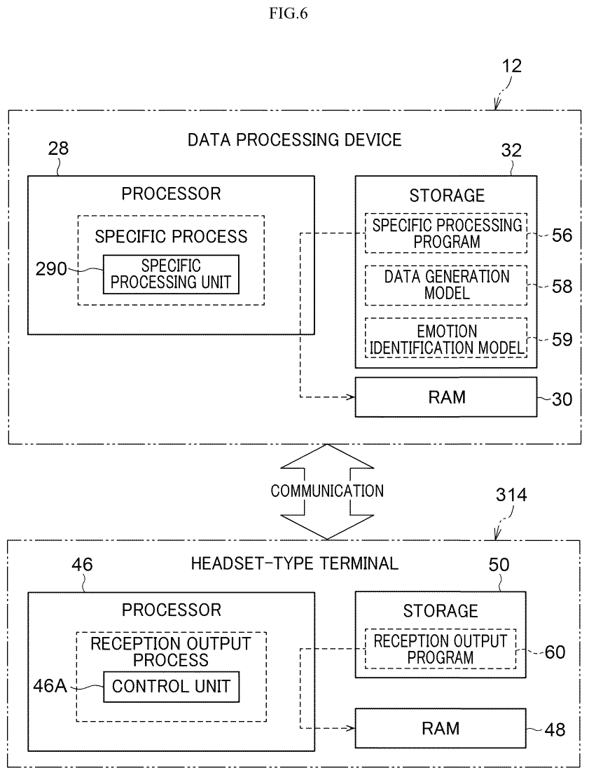

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12.

For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

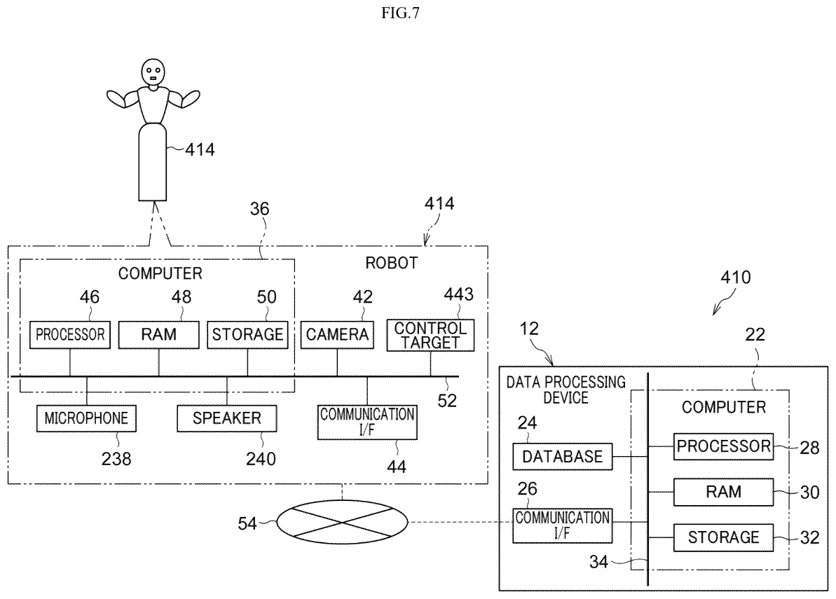

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52.

The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

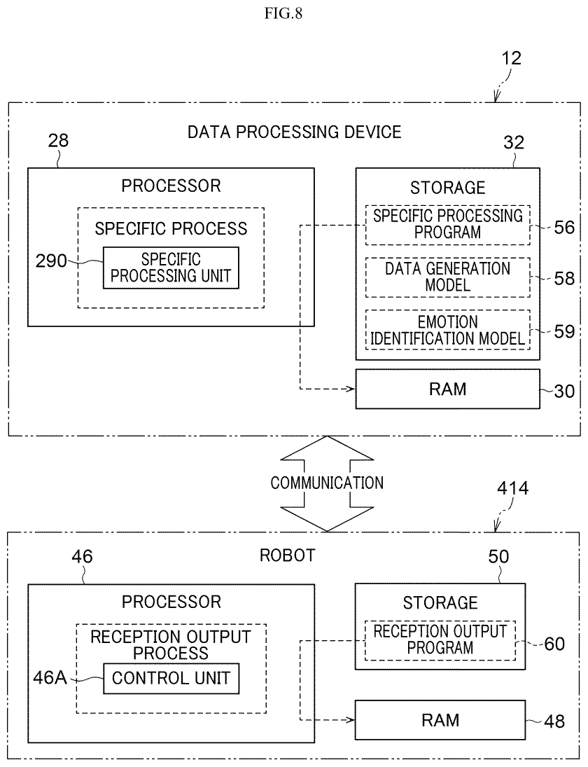

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

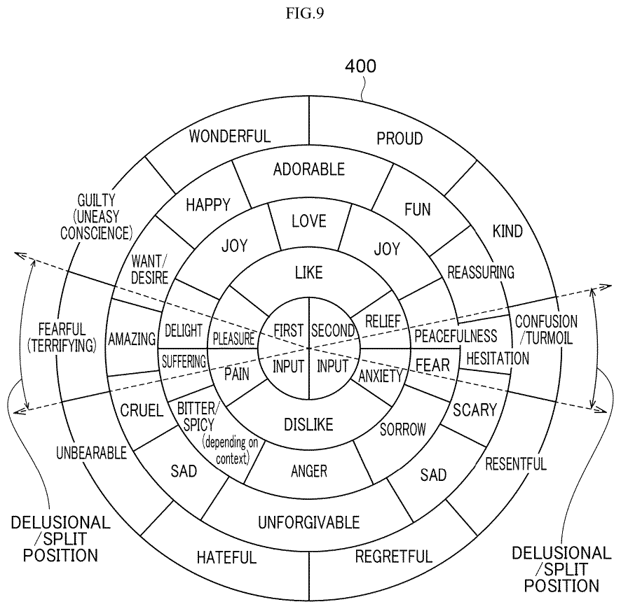

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

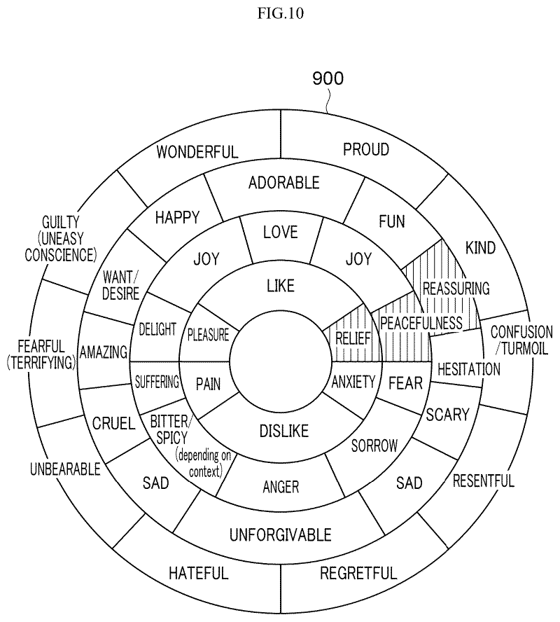

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
model speaking characteristics of a speaker based on audio information and learn patterns of speech tempo and prosody by executing an audio model processing unit,
generate response candidates to inquiries by executing a language processing unit that utilizes a generative AI model,
construct a prompt sentence for input to the generative AI model by dynamically combining inquiry content and related information, input the prompt sentence to the generative AI model, and cause the generative AI model to generate the response candidates by executing a prompt generation unit,
determine speech parameters including speaking rate, prosody, pause position, and sound volume for audio output based on the response candidates and user attribute information by executing a speech control information generation unit,
generate audio-form response data based on the response candidates and the speech parameters by executing a speech synthesis processing unit,
store inquiries, response candidates, speech parameters, and usage history, and perform learning and updating of the generative AI model and the audio model processing unit based on the stored information by executing an information management unit, and
perform user input operations, response display, and audio playback control by executing a user interaction unit.

### (Supplementary 2)

The system according to supplementary 1,
wherein the processor is configured to
extract acoustic features from audio information including a plurality of speakers, situations, and emotional expressions by the audio model processing unit, learn the patterns of speech tempo and prosody used as the speech parameters, and generate speech control information including sentence segmentation and emphasis positions suitable for reading aloud based on the learned patterns of speech tempo and prosody and the user attribute information by the speech control information generation unit.

### (Supplementary 3)

The system according to supplementary 1,
wherein the processor is configured to
generate the response candidates for text-form inquiries by using, as the generative AI model, a pre-trained large-scale generative information processing model in the language processing unit, and generate, in the prompt generation unit, the prompt sentence including an instruction sentence that specifies a degree of use of technical terms, sentence length, writing style, and suitability for speech synthesis based on field-of-use information and usage history information, and input the prompt sentence to the generative AI model so as to generate the response candidates adapted to audio output.

### Application Example 1

### (Supplementary 1)

A system comprising a processor,
wherein the processor is configured to
learn acoustic characteristics including speech tempo and prosody for each speaker based on acoustic information, and generate speaker-specific acoustic model information, and interpret a natural language inquiry sentence obtained from the speaker, based on state information and management information associated with the speaker, and identify a type of the inquiry and target information, and
acquire, in accordance with the type of the inquiry and the target information, schedule information, intake information, nutrition information, state index information, and history information stored in a management information storage unit, and generate context information in a structured form based on the acquired information, and
generate a prompt sentence including the inquiry sentence and the context information, input the prompt sentence to a generative language model, and cause the generative language model to generate a natural language response sentence according to attributes and preferences of the speaker, and
convert the natural language response sentence into acoustic response information in which speech rate, volume, and voice quality are adjusted based on the acoustic model information of the speaker and listening characteristic information of the speaker, and
record the inquiry sentence, the prompt sentence, the natural language response sentence, and the context information in association with each other in time series, and update at least one of generation conditions of the prompt sentence and an expression style of the natural language response sentence based on recorded information, and
transmit the acoustic response information and the natural language response sentence to a terminal device, and cause the terminal device to perform audio output and visual output.

### (Supplementary 2)

The system according to supplementary 1,
wherein the processor is configured to
continuously acquire state index information relating to the speaker including biometric information and activity information, calculate an abnormality index based on transitions of the biometric information and the activity information, and, when the abnormality index satisfies a predetermined condition, transmit alert information to a caregiver terminal, and input, to the generative language model, a prompt sentence including the transitions of the biometric information and management conditions, thereby causing the generative language model to generate an explanatory natural language sentence for the caregiver and add the explanatory natural language sentence to the alert information.

### (Supplementary 3)

The system according to supplementary 1,
wherein the processor is configured to
evaluate comprehensibility or suitability of the natural language response sentence based on evaluation information acquired from the terminal device, and, in accordance with an evaluation result, update at least one of expression constraint information, sentence length control information, and vocabulary control information included in the prompt sentence to be input to the generative language model, thereby adaptively optimizing, for each speaker, the expression style of natural language response sentences generated thereafter.

### Example 2

### (Supplementary 1)

A system comprising a processor,
wherein the processor is configured to
receive, from a terminal device, user input information including at least one of voice information and character information, and perform a speech recognition process on the voice information to generate user utterance character information as first processing,
estimate an emotion state of a user by executing an emotion classification process based on at least one of the voice information, the user utterance character information, and dialog history information, and generate emotion information including emotion types and index values for respective emotion types as emotion estimation,
generate prompt character information to be input to a generative language model by performing string operations on template information based on the user utterance character information, the emotion information, and domain information as prompt generation,
convert the prompt character information into a token sequence, input the token sequence to the generative language model, generate response character information by autoregressive inference, and perform inappropriate expression detection and correction on the generated response character information as response generation,
determine audio style parameters defining at least a speaking rate, a pitch, an intonation, and a volume based on the emotion information and the response character information as audio style determination,
generate and output a synthetic voice signal based on the response character information and the audio style parameters as voice synthesis,
store, in a recording medium, dialog history information including at least the user utterance character information, the emotion information, the prompt character information, the response character information, the audio style parameters, and evaluation information from the user as recording, and
perform learning processing of at least the emotion estimation and the generative language model based on the dialog history information as learning.

### (Supplementary 2)

The system according to supplementary 1,
wherein the processor is configured to
hold a plurality of template information items associated with domain categories and representative emotions included in the emotion information, select a template information item according to a domain category and the representative emotion, and generate the prompt character information by embedding the representative emotion and the user utterance character information into placeholder portions in the selected template information.

### (Supplementary 3)

The system according to supplementary 1,
wherein the processor is configured to
determine, as numerical information, the speaking rate, the pitch, the intonation, and the volume in the audio style parameters based on correspondence information between emotion types and emotion intensities included in the emotion information and the audio style parameters, and generate the audio style parameters to be transmitted to the terminal device.

### Application Example 2

### (Supplementary 1)

A system comprising a processor,
wherein the processor is configured to
receive audio information acquired by a terminal, extract acoustic feature information from the audio information, perform speech recognition to obtain character information from the audio information, estimate emotion state information on the basis of the acoustic feature information and the character information, and record the emotion state information as history information; and
store, in an information storage device, at least a part of attribute information, health state information, schedule information, intake information, medication information, dialogue history information, and the emotion state information with respect to a user, manage the stored information in association with the emotion state information, and dynamically construct a prompt sentence to be input to a generative AI model on the basis of the emotion state information and the information stored in the information storage device; and
input the prompt sentence and the information stored in the information storage device to the generative AI model and cause the generative AI model to generate a response sentence in a natural language format; and
convert the response sentence into audio information while controlling speech rate, sound volume, pitch, and prosody of speech synthesis on the basis of the response sentence, the emotion state information, and the attribute information; and
generate user interface control information, for controlling at least a color scheme, a character size, a display message, and an arrangement of an operation area of a display unit of the terminal, on the basis of the response sentence and the emotion state information, and transmit the user interface control information and the audio information to the terminal; and
aggregate occurrence states of negative emotions on the basis of the emotion state information and the health state information, and, when an aggregation result satisfies a predetermined condition, transmit notification information to a caregiver terminal.

### (Supplementary 2)

The system according to supplementary 1,
wherein the processor is configured to
select different template information depending on whether the emotion state information indicates a neutral state or a negative state including at least one of an anxious state and an angry state, insert the schedule information, the intake information, and the medication information as character strings into a registered-information field of the template information, insert the character information into a question field of the template information, and, in accordance with the negative state, add a conditional sentence relating to addition of a reassuring sentence and suppression of expressions that increase anxiety, thereby generating the prompt sentence.

### (Supplementary 3)

The system according to supplementary 1,
wherein the processor is configured to
use a speech emotion classification model based on the acoustic feature information and a text emotion classification model based on the character information to calculate probability information for each emotion class, integrate the probability information by using predetermined weights to obtain integrated probability information, and determine an emotion label and an emotion intensity on the basis of the integrated probability information as the emotion state information.

What is claimed is:

1. A system comprising:
circuitry configured to:
receive, via a communication interface coupled to a packet-switched network, voice training data and extract acoustic features from the voice training data to train a voice model to learn patterns of speech tempo and intonation;
receive query audio data from a terminal device via the communication interface and convert the query audio data into text data;
generate response text data based on the text data using a generative neural network model; and
convert the response text data into synthesized audio data using a speech synthesis process controlled by the trained voice model for tempo and intonation, and
transmit the synthesized audio data to the terminal device via the communication interface.

2. The system according to claim 1, wherein the voice training data includes audio recordings of a plurality of speakers covering a plurality of situational contexts and emotional expressions, and wherein the voice model comprises a neural network.

3. The system according to claim 2, wherein the acoustic features include at least fundamental frequency contours, energy envelopes, speech rate variations, pause durations, and spectral characteristics, and wherein the voice model comprises a recurrent neural network trained to predict temporal patterns of the acoustic features.

4. The system according to claim 3, wherein the circuitry segments the voice training data by speaker identifier, situational context label, and emotional expression label, and trains the voice model to generate context-dependent and emotion-dependent tempo and intonation parameters.

5. The system according to claim 4, wherein the circuitry detects an emotional state of a user from the query audio data based on prosodic features and selects corresponding emotion-dependent parameters from the voice model to generate the synthesized audio data with emotionally responsive intonation.

6. The system according to claim 5, wherein the circuitry adjusts the speech rate and pause distribution of the synthesized audio data based on the detected emotional state, using slower speech rate and longer pauses when the detected emotional state indicates distress, and using natural conversational pace when the detected emotional state indicates neutral engagement.

7. The system according to claim 1, wherein the generative neural network model comprises a transformer-based architecture with a plurality of self-attention layers, and wherein the circuitry constructs a prompt data structure encoding the text data and dialog context data stored in a storage device to generate the response text data.

8. The system according to claim 7, wherein the generative neural network model is a pre-trained large-scale language model, and wherein the circuitry performs domain-specific fine-tuning of the large-scale language model using a training dataset prepared for a specific operational domain stored in the storage device.

9. The system according to claim 8, wherein the circuitry maintains and updates the training dataset based on interaction log data accumulated during operation, and periodically retrains the large-scale language model to improve response accuracy for the specific operational domain.

10. The system according to claim 1, wherein the circuitry performs speaker identification on the query audio data to identify a returning user, retrieves interaction history data associated with the identified user from a storage device, and incorporates the interaction history data into generation of the response text data for personalized response generation.

11. The system according to claim 10, wherein the circuitry tracks user satisfaction indicators including conversation duration, query repetition frequency, and explicit feedback data, and adjusts response generation parameters based on the tracked indicators.

12. The system according to claim 11, wherein the circuitry generates a user engagement report by aggregating the satisfaction indicators across a plurality of interaction sessions, and transmits the user engagement report to an administrative terminal device.

13. The system according to claim 1, wherein the circuitry is further configured to receive text query data from the terminal device as an alternative to the query audio data, and to generate the response text data and the synthesized audio data from the text query data.

14. The system according to claim 13, wherein the circuitry determines an output modality based on the input modality, transmitting synthesized audio data in response to audio queries and transmitting text response data in response to text queries, while maintaining consistent response content across modalities.

15. The system according to claim 1, wherein the circuitry supports concurrent voice interactions from a plurality of terminal devices, maintains separate dialog context data for each terminal device in a storage device, and processes each interaction independently while sharing the trained voice model and generative neural network model.

16. The system according to claim 15, wherein the circuitry allocates processing resources for each concurrent interaction based on a priority queue, and ensures response latency remains below a target threshold by dynamically adjusting generation parameters.

17. The system according to claim 1, wherein the circuitry generates multiple candidate response text data from the generative neural network model, evaluates each candidate based on relevance score, coherence score, and safety score, and selects the highest-scoring candidate as the response text data.

18. A system comprising:
circuitry configured to:
receive, via a communication interface coupled to a packet-switched network, query audio data from a terminal device and convert the query audio data into text data using a speech recognition model;
detect an emotional state of a user from the query audio data based on prosodic features including fundamental frequency contours, energy envelopes, and speech rate variations;
generate response text data by constructing a prompt data structure encoding the text data and dialog context data and transmitting to a generative neural network model comprising a transformer architecture with a plurality of self-attention layers;
select emotion-dependent tempo and intonation parameters from a trained voice model comprising a recurrent neural network based on the detected emotional state;
convert the response text data into synthesized audio data using a speech synthesis model controlled by the selected tempo and intonation parameters; and
transmit the synthesized audio data to the terminal device via the communication interface.

19. The system according to claim 18, wherein the circuitry is further configured to evaluate multiple candidate responses using relevance, coherence, and safety scores, and to select the highest-scoring candidate.

20. A method performed by circuitry of a server coupled to a packet-switched network via a communication interface, the method comprising:
receiving, via the communication interface, voice training data and extracting acoustic features from the voice training data to train a voice model to learn patterns of speech tempo and intonation;
receiving query audio data from a terminal device and converting the query audio data into text data;
generating response text data based on the text data using a generative neural network model; and
converting the response text data into synthesized audio data using a speech synthesis process controlled by the trained voice model for tempo and intonation, and transmitting the synthesized audio data to the terminal device via the communication interface.
